(19) United States
(12) Patent Application Publication
(10) Pub. No.: US 2020/0182637 A1
(43) Pub. Date: Jun. 11, 2020

(54) SYSTEMS AND METHODS FOR IMPLEMENTING MULTI-MODAL TRANSPORT

(71) Applicant: Zunum Aero, Inc., Bothell, WA (US)

(72) Inventors: Ashish Andrew KUMAR, Bellevue, WA (US); Burton Matthew KNAPP, Redmond, WA (US)

(73) Assignee: Zunum Aero, Inc., Bothell, WA (US)

(21) Appl. No.: 16/315,911

(22) PCT Filed: Jul. 7, 2017
(86) PCT No.: PCT/US2017/041266

§ 371 Date: Feb. 21, 2019

Related U.S. Application Data
(60) Provisional application No. 62/359,211, filed on Jul. 7, 2016.

(51) Int. Cl. G01C 21/34; G06Q 50/30; G06Q 10/02; G06Q 10/04

(52) U.S. Cl. CPC G01C 21/3423; G01C 21/343; G06Q 10/047; G06Q 10/025; G06Q 50/30

(57) ABSTRACT

Systems, apparatus, and methods for implementing multi-modal transport transform generalized transport objectives for a segment of a journey from an origin to destination (e.g., as specified by a traveler or shipper) into generalized and specific transport requests to various sources/providers of transport services (e.g. operators, platforms and marketplaces) across different modes of transport. In one example, generalized and specific itineraries received from various sources/providers of transport services are managed to meet objectives, and are requested iteratively over time, up to the day of transport, to seek improvements toward meeting transport objectives. In another example, real-time monitoring of different legs of a journey across a transport segment leverages flexibility and addresses changeability options. In other aspects, the flexibility afforded by generalized transport requests and generalized itineraries allows providers of transport services to significantly improve matching of capacity to demand for the transport services.

### CROSS-REFERENCE TO RELATED APPLICATIONS

This application claims priority under 35 U.C.S. § 371 to, and is a U.S. National Phase entry of, International Application No. PCT/US2017/041266, filed Jul. 7, 2017, which claims a priority benefit to U.S. Application Ser. No. 62/359,211, entitled “System and Method for Implementing Fast and Flexible Multi-modal Transport,” filed on Jul. 7, 2016, the disclosure of each of which is incorporated herein by reference in its entirety.

### BACKGROUND

Transportation systems and transport platforms are an important part of the infrastructure used to enable commerce and the movement of people between locations. As such, they are essential services for the growth of an economy and the development of a society. Over the years, several types of transportation systems have been developed, each typically with their own focus, advantages and drawbacks.

A key challenge for transportation is the opening up of a “gap” over regional distances, where much of the world is left without a high-speed mode. Competitive pressures have driven a 70-year decline of air over these distances. And the impact of high-speed rail is limited by economics to a few dense corridors. As a result, the last time the US travel survey was conducted in 2001, 90 percent of all long-distance trips were over regional distances from 50 to 500 miles. Yet just 2 percent of these were by air, with auto at a staggering 97 percent. This has had a tremendous impact on mobility and economic development. Regional door-to-door mobility has stagnated: travel times by highway have not improved for decades; and flight times have stretched given slower cruise speeds and increasingly congested airports. Meanwhile, the steady consolidation of air services to a declining set of major hubs has left many communities disconnected from the global air network, with severe impact on their economy and ability to attract investment.

### SUMMARY

The Inventors have recognized and appreciated that the rigidity of the current conventional air transport system is poorly suited to regional trips, contributing to the minute and declining role of air over these distances. Shorter regional trips are much more numerous than long-distance travel. They are also much more fluid. Travel over these distances is planned far less in advance and around events that are much more variable. And even modest shifts in the schedule, a few hours here or there, can swing preference away from air. As a result, current revenue and change management practices are hugely damaging. Fare levels discourage trips on short notice, and change penalties discourage trips where dates or schedules are uncertain. And processes to execute change are often restrictive and complex. For example, change is limited to services of the original operator, and the remaining legs need to be separately modified to match.

The Inventors also have recognized and appreciated that another shortcoming relating to the current conventional air transport system today is the inability of operators to tailor schedules and equipment to evolving demand over timeframes shorter than weeks or months. This translates to sub-optimal yields and more critically, to lost revenue as operators rationalize routes to focus on the more profitable. The concentrated air network, comprised of large aircraft serving a declining set of major hubs, restricts this today. Standardization of fleets to a few large platforms means there is limited ability to tailor capacity to demand. Moreover, landing slots at many hubs are fixed far in advance. This rigidity of the air network is compounded by business practices. Yield and revenue management are based on discrete itineraries locked months in advance. And absence of information on passenger or shipper needs, beyond discrete itineraries, means that operators are presented with artificially rigid demand.

The Inventors further recognize and appreciate that the landscape of regional transport is poised for dramatic change as sharing, electrification and autonomy converge to enable fast and flexible regional transport at scale. Intra-urban travel is being reshaped by ridesharing, car sharing, car and van pooling. Electric vehicles and driverless technologies will take this further. Lower fares, improved productivity and reduced congestion will dramatically expand utility and extend range. As recognized by the inventors, the transformation on the ground will take to the skies, extending impact of this “new transport” to regional, and eventually, intracontinental ranges. A new breed of small- to mid-sized hybrid-electric aircraft, some of which have been innovated by the Inventors, will usher in a new golden era of regional air. Frequent departures of smaller aircraft from a large number of smaller airfields will enable air travel much faster than today and at much lower fares. Over time, rapidly improving batteries will further reduce costs and extend range, while increasing acceptance of drones will gradually reduce the need for pilots onboard, accelerating the trend.

As recognized by the inventors, the scale-out of air transport via small to mid-sized aircraft flying regional ranges is a direct result of the unique operating economics of range-optimized hybrid-electric aircraft, enhanced further by future autonomy. Conventional aircraft are scale and range advantaged. Larger aircraft are more efficient, as are flights over longer ranges, than smaller aircraft or shorter flights. These economies of scale and range have powered the long-term transition of aviation to large, long-haul aircraft and high-volume hubs, destroying the utility of regional air. In contrast, hybrid-electric aircraft are free of the scale and range economics that plague regional aviation today. Smaller electric aircraft fly as efficiently as (or in some instances more efficiently than) larger ones. And relatively small electrics flying regional are competitive with the largest conventional jets flying long-haul. Released from the constraints of scale and range, operators of future long-distance trips will mold aircraft, frequency and routes to travel patterns. The air network that emerges will be distributed, with frequent flights to a large number of community and urban airports, a contrast to the concentrated network of today.

As noted earlier, electric aircraft are poised to upturn the rigidity of air transport via vastly expanded services to numerous urban and community airfields. The inventive systems and methods complement this shift by expanding the flexibility of managing journeys (or “trips”) by travelers, or for objects transported on behalf of shippers, to include flexible long-distance legs as well as one or more local legs to address the full extent of door-to-door transport needs. In various aspects, these systems and methods include dynamic capacity management processes for improved tailoring of capacity to demand, from individual itineraries, to schedules, equipment and even routes.

As recognized by the inventors, a focus on the full extent of door-to-door transport needs creates a pathway to a much more flexible transport system. Platforms today are focused on legs connecting one transport terminal to another, most often on a single mode. This narrow scope translates to a system that is artificially rigid given operators and travelers engage over to a discrete itinerary, which once reserved can be expensive to change. In reality, transport needs are much more fluid, in spite of some portions of trips often being restricted to time windows defined by hard constraints (where perceived benefits of the journey decrease steeply, or perceived costs increase steeply). Within a time window, however, benefits and costs vary more gradually, creating room for flex. By addressing the full extent of a traveler's or shipper's needs, the inventive system and methods facilitate this enhanced flexibility to transport, enabling leverage by travelers, shippers and operators in a variety of ways for system-wide value.

These and other aspects of the inventive concepts disclosed herein are designed to enable one or more of the following, which collectively deliver fast and flexible regional transport, coupled with mechanisms to enable operators to maximize yield:
Orchestrate transport to meet end-to-end needs from origin to destination across modes, versus focus today on terminal-to-terminal legs, typically on single modes.
Orchestrate transport to meet transport objectives in time and space including full extent of flexibility of these, versus focus today on specific departures from specific terminals.
Orchestrate transport in ways that leverage the flexibility and address the changeability of objectives, versus rigid reservations of specific departures from specific terminals.
Orchestrate transport across modes and operators offering fixed or variable schedules, on-demand and shared services, versus split today by mode and operator business model. Also enable travelers (and shippers) to collaborate to meet their individual transport needs.
Assist with selection of candidate mode options (e.g., optimal mode options) for the long-distance legs, leveraging a range of 3rd party platforms for local legs. Modes covered include commercial air (few hubs), future regional air (many airfields), flight-sharing, on-demand and charter air (many airfields), rail and high-speed rail (few terminals), car, shuttle and bus.
Enable operators to capitalize on flexibility by optimizing supply based on evolving demand, versus preponderance of fixed schedules today.
Reserve itineraries in a way that continually optimizes transport across changing supply, transport conditions and transport needs over time, versus rigid reservations today. Orchestrate multi-modal journeys in real-time.

Embodiments of the invention are directed to systems, apparatuses, and methods for providing fast and flexible intermodal transport for passengers and cargo. In some embodiments, the inventive air transport system and associated aircraft include one or more of the following elements, functionality, or features:
1. Fast, flexible multi-modal system for the transport of passengers and cargo
2. System to orchestrate fast and flexible multi-modal transport
3. Method to describe door-to-door transport needs via traveler/shipper objectives and preferences
4. Method to use generalized transport requests and reservations for flexibility
5. Method to use generalized transport records to enable supply-demand matching
6. Method to identify segment options that optimize door-to-door transport utility
7. Methods to assist with the candidate reservation (e.g., optimal reservation) of multi-modal transport
8. Methods to orchestrate multi-modal journeys in real-time
9. Methods to enable operators to optimize supply to changing transport demand
10. Methods to enable travelers (or shippers) to share and trade transport
11. Methods for multi-modal transport monitoring and forecasting

In some inventive aspects, a method for generating a multi-modal itinerary for a journey is described herein. The journey can comprise of at least a first segment defined by a first origin and a first destination. The first segment can include a plurality of legs. The plurality of legs can include at least a first long-distance leg that is defined by a first departure terminal and a first arrival terminal respectively that correspond to first start and end points of the first long-distance leg. The plurality of legs can also include at least a first local leg that is defined by one of: the first origin of the first segment and the first departure terminal of the first long-distance leg and the first arrival terminal of the first long-distance leg and the first destination of the first segment. The first long-distance leg can include at least a first long-distance transport mode having one of a Fixed Schedule (FS) model, a Variable Schedule (VS) model, and an On-Demand (OD) schedule model provided by a first operator or a first marketplace participant between the first departure terminal and the first arrival terminal.

In some inventive aspects, the method comprises receiving a first objective for the first segment of the journey. The first objective comprises first origin coordinates for the first origin of the first segment, first destination coordinates for the first destination of the first segment, and a first time window for the first segment. The first time window comprises a departure time specification for the first origin of the first segment and an arrival time specification for the first destination of the first segment.

The method also comprises using the received first objective, querying a mode/origin-destination (M/OD) database. The M/OD database can include a plurality of origin-destination pairs respectively corresponding to different long-distance leg. At least a first origin-destination pair of the plurality of origin-destination pairs can include a departure terminal for a long-distance leg, an arrival terminal for the long-distance leg, a long-distance transport mode and corresponding duration for the long-distance mode between the departure terminal and the arrival terminal for the long-distance leg, at least one of an operator, a platform, and a marketplace that provides the long-distance transport mode, and at least one local leg transport mode option corresponding to the departure terminal and the arrival terminal for the long-distance leg. The long-distance transport mode can include at least one of a long-haul air transport mode, a regional air transport mode, a railway transport mode, and a highway transport mode. The long-distance mode can have one of a VS model and an OD schedule model.

In some inventive aspects, in response to querying the M/OD database, the method also comprises building a list of long-distance transport mode options for the first long-distance leg by selecting from the M/OD database at least a first candidate origin-destination pair as at least a first long-distance transport mode option for the first long-distance leg. The first candidate origin-destination pair can include a first candidate long-distance transport mode having a VS model or an OD schedule mode. The first candidate origin-destination pair can be selected based at least in part on at least one of: at least one of a first distance and a first transit time between the first origin coordinates for the first origin of the first segment and the departure terminal of the first candidate long-distance transport mode and at least one of a second distance and a second transit time between the arrival terminal of the first candidate long-distance transport mode and the first destination coordinates for the first destination of the first segment.

In some inventive aspects, for at least the first long-distance transport mode option of the list of long-distance transport options that are built as described above, the method further comprises determining an estimated duration for the at least one local leg transport mode option corresponding to the departure terminal for the first candidate long-distance transport mode. The method comprises converting the first departure specification of the first time window for the first segment to a converted first departure specification for the first candidate long-distance transport mode based at least in part on the estimated duration for the at least one local leg transport mode option. The method also comprises transmitting via the Internet a first generalized transport request to at least one of a first candidate operator, a first candidate platform, and a first candidate marketplace indicated in the first candidate origin-destination pair corresponding to the first long-distance transport mode option. The first generalized transport request can include the departure terminal and the arrival terminal indicated in the first candidate origin-destination pair corresponding to the first long-distance transport mode option and the converted first departure specification.

In some inventive aspects, the method comprises in response to the first generalized transport request, receiving via the Internet, from the at least one of the first candidate operator, the first candidate platform, and the first candidate marketplace, a first candidate itinerary for the first long-distance leg of the first segment. The first candidate itinerary is a generalized itinerary comprising a first travel departure window, a first travel duration, and a first fare for the first long-distance leg of the first segment.

In some inventive aspects, a computer-facilitated method for monitoring the progress of a traveler or a shipped object during a first segment of a journey and updating an itinerary for the first segment of the journey to meet a first objective for the first segment is described herein. The first segment can be defined by a first origin and a first destination. The first objective can comprise first origin coordinates for the first origin of the first segment, first destination coordinates for the first destination of the first segment, and a first time window for the first segment. The first time window can comprise a departure time specification for the first origin of the first segment and an arrival time specification for the first destination of the first segment. The first segment can include a plurality of legs. The first plurality of legs can include at least a first long-distance leg defined by a first departure terminal and a first arrival terminal respectively corresponding to first start and end points of the first long-distance leg. The first plurality of legs can also include at least a first local leg defined by one of: the first origin of the first segment and the first departure terminal of the first long-distance leg and the first arrival terminal of the first long-distance leg and the first destination of the first segment. The first long-distance leg can include at least a first long-distance transport mode having one of a Fixed Schedule (FS) model, a Variable Schedule (VS) model and an On-Demand (OD) schedule model provided by a first operator between the first departure terminal and the first arrival terminal. The first local leg can be provided by a second operator different from the first operator.

In some inventive aspects, the method comprises building a timeline for the first segment prior to the journey. The timeline can be built based at least in part on respective forecasted durations for the first long-distance leg and the first local leg. The timeline comprises a plurality of expected times and corresponding locations of the traveler or shipped object during the first segment.

In some inventive aspects, during the journey, the method comprises determining a current leg of the first segment from the timeline for the first segment and a current time. If the current leg of the first segment is the first long-distance leg, the method comprises, transmitting via the internet, a first query to the first operator and receiving from the first operator a first long-distance leg arrival status of the first long-distance leg. If the current leg of the first segment is the first local leg, the method comprises, monitoring a current location of the traveler or the shipped object. If the first long-distance leg arrival status significantly deviates from a corresponding expected time according to the timeline, or if the current location of the traveler or the shipped object significantly deviates from a corresponding expected location according to the timeline, the method comprises, generating an updated itinerary for at least one subsequent leg of the first segment.

In some inventive aspects, a computer-facilitated method for generating a daily schedule for a plurality of long-distance transport mode trips by a transportation operator is disclosed herein. The method comprises determining a first provisional schedule on a given day for the plurality of long-distance transport mode trips based on a forecast demand for capacity. The respective long-distance transport mode trips of the plurality of long-distance transport mode trips can have corresponding itineraries. A first number of the corresponding itineraries can be specific itineraries including a departure terminal, an arrival terminal, a departure time, and a duration for a corresponding long-distance transport mode trip. A second number of the corresponding itineraries can be generalized itineraries including at least one of a departure terminal, an arrival terminal, a travel window, and a duration for a corresponding long-distance transport mode trip.

After determining the first provisional schedule, in some inventive aspects, the method comprises, receiving from a plurality of travelers and/or shippers, a plurality of transport requests for at least some of the plurality of long-distance mode trips on the given day.

In some inventive aspects, the method comprises, updating the first provisional schedule based at least in part on the plurality of transport requests received. The first provisional schedule can be updated to determine a second schedule for the plurality of long-distance transport mode trips by increasing the first number of specific itineraries and decreasing the second number of generalized itineraries.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Other systems, processes, and features will become apparent to those skilled in the art upon examination of the following drawings and detailed description. It is intended that all such additional systems, processes, and features be included within this description, be within the scope of the present invention, and be protected by the accompanying claims.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates sample multi-modal travel options from an origin of a segment of a trip or journey to a destination of the segment of the trip or journey, in accordance with some inventive aspects.

FIG. 2 is an illustration of a segment of a trip or journey from an origin to a destination, wherein the segment comprises multiple legs, in accordance with some inventive aspects.

FIG. 3 is a block diagram of an example of a system to facilitate management of multi-modal travel, in accordance with some inventive aspects.

FIG. 4 is illustrates a timeline of multiple concurrent processes implemented by the system of FIG. 3, in accordance with some inventive aspects.

FIGS. 5A and 5B illustrate displays of mode options (e.g., presented via a user interface of a computing device) based on transport objectives (e.g., of a traveler or shipper) between an example origin and destination (e.g., from Palo Alto to Pasadena), in accordance with some inventive aspects.

FIG. 6 is an illustration of a display of itinerary options based on one or more generalized transport requests for travel based on the mode options shown in FIGS. 5A and 5B, in accordance with some inventive aspects.

FIG. 7 illustrates a glossary defining symbols used to communicate itinerary status in the various displays disclosed herein, in accordance with some inventive aspects.

FIGS. 8A and 8B illustrate a travel dashboard showing travel progress on a segment from the origin to the destination shown in FIGS. 5A, 5B and 6, in accordance with some inventive aspects.

FIG. 9 is a diagram illustrating an origin and destination of a segment of a trip or journey, and respective specified radii of departure terminal and arrival terminal options based on distances or transit times from the origin and destination, in accordance with some inventive aspects.

FIG. 10 is a flowchart to determine mode options for undefined legs of a segment, in accordance with some inventive aspects.

FIG. 11 is a flowchart to determine candidate itineraries for one or more legs of a travel segment, in accordance with some inventive aspects.

FIG. 12 is a flowchart to build or update a timeline for a travel segment, in accordance with some inventive aspects.

FIGS. 13A-13F illustrate itinerary options for an example segments of a trip (e.g., from Palo Alto to Pasadena) evolving over time to a final reserved itinerary, in accordance with some inventive aspects.

FIG. 14 is a flowchart to build a workflow for a segment, in accordance with some inventive aspects.

FIG. 15 is a flowchart to assess risk or opportunity for a transport objective for a segment of a trip or journey and initiate redesign, in accordance with some inventive aspects.

FIG. 16A is a flowchart to redesign transport when transport objectives are at a risk and when an itinerary has been reserved.

FIG. 16B is a flowchart to redesign transport when transport objectives are at risk and when no itinerary has been reserved.

FIG. 17 is a graph depicting an operator's view of fixed and provisional reservations issued from schedule initialization through day of travel, in accordance with some inventive aspects.

FIG. 18 illustrates elements and/or components in a computer device or system configured to implement a method, process, function, or operation in accordance with some inventive aspects.

### DETAILED DESCRIPTION

The present disclosure describes inventive systems, apparatus, and methods for implementing multi-modal transportation. In various aspects, the systems and methods disclosed herein transform generalized transport objectives into generalized and specific transport requests, and corresponding generalized and specific itineraries from various providers of transport services. In addition, real-time monitoring of a journey leverages flexibility and addresses changeability options. In some inventive aspects, the systems and methods disclosed herein enable operators and providers of transport services to significantly improve matching of capacity to demand for the transport services in a flexible manner, based at least in part on generalized transport requests and generalized itineraries as part of the planning process for one or more segments of a journey.

As mentioned above, a key challenge for transportation is the opening up of a “gap” over regional distances, where much of the world is left without a high-speed mode. The regional distances are usually covered by long-distance commercial flights. In fact, a large fraction of commercial aircraft and business jet flights are less than 1500 miles. With the advent of small to mid-sized regional electric aircrafts, regional transportation is poised for a change. Thus, transportation over “long-distances,” such as distances between approximately 50 to 500 miles, or a couple of hundred miles up to approximately 1000 miles, or from approximately 1000 miles to 3500 miles, or even greater than 3500 miles can be covered by short-haul regional flights, medium-haul regional flights, and long-haul flights, respectively. In addition, other modes of transportation (e.g., train, bus, personal vehicles, personal flights, and/or the like) may also be used to cover long distances.

Consequently, an expanded source of providers and/or operators can provide transport options for long-distance legs of a journey, including providers/operators that may offer variable schedule models or on-demand schedule models. With these expanded sources of providers/operators, a need for a platform that is compatible with a variety of scheduling models and platforms/operators arises. In response to this need, the systems and methods disclosed herein provide end-to-end transport needs over multiple modes of transport from multiple providers/operators. These systems and methods provide compatibility with a wide range of scheduling models and enable an expanded source of operators (e.g., fixed schedule, variable schedule, and on-demand). Thus, the travel segments of multiple legs of a trip can be planned in a flexible manner. In particular, an initial flexible itinerary can be created, reserved, and held before the journey begins. The itinerary can be periodically refreshed and compared with other options to determine a candidate itinerary (e.g., optimal itinerary). The itinerary can be modified and/or changed based on this comparison to accommodate for lower fares and lower travel times for one or more legs or for the overall segment, or to accommodate for faster connections between legs, a combination thereof, and/or the like.

In some inventive aspects, one or more itineraries for respective legs of a journey can be booked prior to the start of the journey. Once the journey begins, the systems and methods disclosed herein can monitor the journey via applications such as Global Positioning System (GPS) to determine the location of the traveler/shipped object at a given point in time. Various providers of the respective legs (e.g., long-distance operators or local platforms) can be queried for status updates such that the itinerary is modified to account for delays. In addition, the systems and methods disclosed herein can facilitate real-time monitoring of various platforms (e.g., weather, traffic, etc.) to determine possible delays or issues that may occur during a leg. Once the itinerary is updated in real time, changes can be made to subsequent legs remaining in the journey such that the original objectives of the travel request can be approximately met (e.g., arrival time/arrival window at segment destination).

Current transport platforms are focused on the long-distance leg and the limited and typically rigid alternatives for this leg, such as air, rail, bus. As a result, they are far less effective for regional journeys where local legs, including transfer through long-distance terminals, account for a much greater fraction of the journey. The limited usefulness of these platforms will erode even further in coming years as transport modes multiply and as flexibility of the modes increases. Emerging trends around sharing, autonomy and electrification on the ground and in the air will give rise to a new breed of fast and flexible transport options that are multi-modal, increasingly electrified and increasingly autonomous.

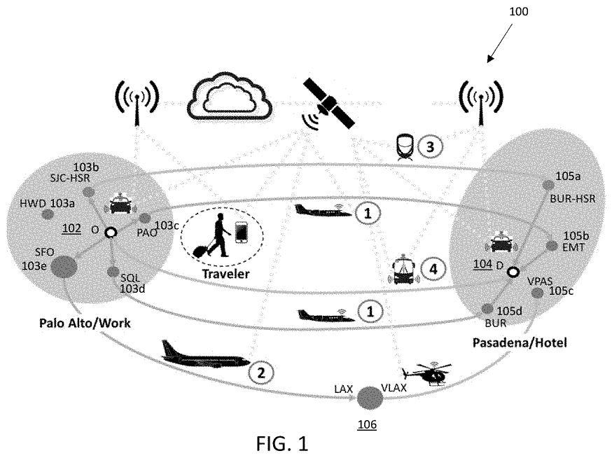

In contrast, the focus of the systems and methods disclosed herein is end-to-end transport, from an origin to a destination of a segment of a journey (for example, origin 102 to destination 104 in FIG. 1), via multiple transport modes, at least some of which may be flexible scheduled and reserved over some period of time prior to the journey. FIG. 1 illustrates sample fast multi-modal travel options from an origin 102 to a destination 104 in accordance with some inventive aspects. A transportation platform as disclosed herein can determine candidate options for end-to-end transportation for a traveler from origin 102 to destination 104. For instance, the platform determines transportation hubs (also referred to as “transportation terminals”) within a radius of the origin 102 and destination 104. In some inventive aspects, the radius to determine transportation terminals can be defined by the traveler/user of the platform.

In one example, the platform determines five possible departure terminals (also referred to as “origin hubs”), for example, 103a-103e (collectively, departure terminals 103) and four possible arrival terminals (also referred to as “destination hubs”), for example, 105a-105d (collectively, arrival terminals 105). In some inventive aspects, the traveler can be connected from the origin 102 to the departure terminal 103 via flexible local transportation (e.g., taxi, personal vehicle, Uber™, local bus, local subway). In a similar manner, the traveler can be connected from the destination 104 to the arrival terminal 105 via flexible local transportation.

In some inventive aspects, the platform can determine a single mode or multiple modes of transportation for every departure terminal 103—arrival terminal 105 pair. For example, the platform determines that regional aircraft can connect the departure terminal 103c—arrival terminal 105b pair as well as the departure terminal 103d—arrival terminal 105d pair. In a similar manner, the platform determines that a train can connect the departure terminal 103b—arrival terminal 105a pair. In some inventive aspects, the platform can determine a single mode of transportation that connects origin 102 to destination 104. In the example illustrated in FIG. 1, the platform determines that a bus can connect origin 102 to destination 104.

In some inventive aspects, the platform can divide the journey segment between a departure terminal 103 to a arrival terminal 105 into multiple legs and determine different modes of transportation for each leg. For example, the platform determines one or more mid-terminal (also referred to as “mid-hub”) 106 that is located in between the origin 102 and the destination 104. The platform then determines a mode of transportation for the departure terminal 103e—mid-terminal 106 pair and for the mid-terminal 106—arrival terminal 105c pair. For example, the platform determines that the departure terminal 103e can be connected to the mid-terminal 106 via a long-distance aircraft and that the mid-terminal 106 can be connected to the destination-terminal 105c via a personal flight. In this manner, inventive aspects disclosed herein provides a seamless platform that stitch multi-modes of transportation for fast and flexible transport of passengers and cargo.

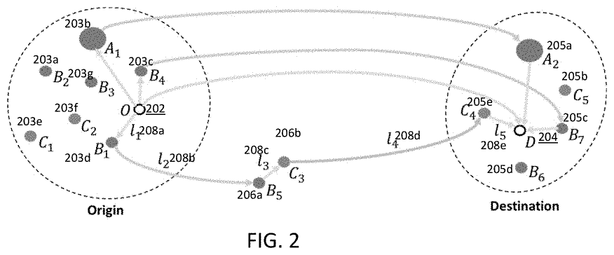

FIG. 2 is an illustration of a segment of a trip or journey, wherein the segment comprises an origin 202 and a destination 204, and multiple legs between the origin and destination, such as legs 208a to 208e, in accordance with some inventive aspects. The legs may include local and largely flexible legs, such as leg 208a, from Origin 202 to a departure terminal 203d, and leg 208e, from arrival terminal 205e to Destination 204. One or multiple long-distance legs (e.g., leg 208b to leg 208d) connect the departure terminal 203d to the arrival terminal 205e, or the origin 202 to the destination 204 or a combination thereof.

The range of transport modes considered for the local and long-distance legs are shown in Table 1. The range of modes include, but are not limited to, (A) Long-haul air to hub airports, (B) Regional air to hub and non-hub airports, piloted and drones, conventional or vertical take-off and landing (CTOL or VTOL), (C) Rail to terminals, low and high-speed, (D) Highway to terminals or door-to-door, driven or autonomous. These different modes may be served by a range of operators with differing models such as Fixed schedules (FS), e.g., long-haul air, regional air, rail; Variable schedules (VS), e.g., regional air, highway; On-demand (OD), e.g., regional air, highway. Local legs between Origin, Destination and terminals may be covered by personal vehicle, Public transit on a fixed schedule (FS) (e.g., bus, rail, ferry), or a large variety of FS, VS and OD operators offering two-wheelers, cars, vans, buses, trucks, even aircraft.

TABLE 1

| Mode | Segments | Description |
|---|---|---|
| Long-haul | FS, VS and OD | Large conventional aircraft, |
| air | | gradually evolving to hybrid- |
| | | electric, operating to a small |
| | | number of high-volume |
| | | hubs. |
| Regional | FS, VS and OD | Small to mid-sized aircraft, |
| air | | largely hybrid-electric, |
| | | operating to a large number of |
| | | airfields, including feeders |
| | | to the major hub airports. |
| | | Piloted and drones. Includes |
| | | conventional take off and |
| | | landing, short take-off and |
| | | landing or vertical take-off |
| | | and landing. |
| Railway | Conventional and | Slow or fast train services |
| | High-speed | to stations along a fixed |
| | | railway line, almost always on |
| | | a fixed schedule. |
| Highway | Own, FS, VS and OD | Own: Personal vehicle |
| | | FS and VS: Shared vehicles, |
| | | driven or autonomous |
| | | OD: Vehicle rentals, driven |
| | | or autonomous |
| Local | Own, Public, FS, VS | Own: Personal vehicle |
| | and OD | Public: including bus, |
| | | subway, trains, trams |
| | | FS and VS: Shared vehicles, |
| | | driven or autonomous |
| | | OD: Vehicle rentals, driven |
| | | or autonomous |

A specific example is shown in FIG. 1 for a journey of a traveler from work in Palo Alto to attend a conference at a hotel in Pasadena. Four multi-modal itinerary options are explored by the platform based on the long-distance leg: (1) regional air from departure terminal PAO 103c or departure terminal SQL 103d to arrival terminal EMT 105b or arrival terminal BUR 105d; (2) long-haul air from departure terminal SFO 103e to mid-terminal LAX 106 connecting to regional air from mid-terminal VLAX 106 to arrival terminal VPAS 105c (ports for vertical take-off aircraft); (3) high-speed rail from departure terminal HSJC 103b to arrival terminal HBUR 105a; and (4) door-to-door personal vehicle from origin 102 to destination 104. Travel from origin 102 to the departure terminals, such as PAO, SQL, SFO and HSJC is by local legs, as is travel from the arrival terminals, such as BUR, EMT, VPAS and HPAS, to destination 104. A detailed mode of transportation for the specific example in FIG. 1 is disclosed in detail in Table 2. Similar detail for a cargo trip from Reno to Pasadena is shown in Table 3.

TABLE 2

| | Leg A | Leg B | Leg C |
|---|---|---|---|
| 1 | Palo Alto/Work | SQL-PAO-HWD | BUR-EMT |
| | to SQL-PAO-HWD | to BUR-EMT | to Pasadena/Hotel |
| | OD or VS vehicle | OD, FS or VS regional | OD or VS vehicle |
| | | aircraft, | |
| | | piloted or drone | |
| 2 | Palo Alto/Work to | SQL-PAO-HWD-SJC-SFO | VLAX to |
| | SQL-PAO-HWD-SJC-SFO | to LAX | VPAS (Pasadena/Hotel) |
| | OD or VS vehicle | FS or VS | OD, FS or VS VTOL |
| | | long-haul or regional aircraft | regional aircraft, piloted or |
| | | | drone |
| 3 | Palo Alto/Work | San Jose HSR | HBUR |
| | to HSJC | to Burbank HSR | to Pasadena/Hotel |
| | OD or VS vehicle | High-speed rail | OD or VS vehicle |
| 4 | Origin to destination | | |
| | OD or VS vehicle | | |

TABLE 3

| | 1 | 2 | 3 | 4 |
|---|---|---|---|---|
| 1 | NV-RDC to | BUR depot to | | |
| | BUR depot | Pasadena/Office | | |
| | VS regional | OD regional | | |
| | drone or | drone or | | |
| | VS truck | VS van | | |
| 2 | NV-RDC | RNO | LAX | BUR depot to |
| | to RNO | to LAX | to BUR depot | Pasadena/Office |
| | VS regional | FS or VS | VS regional | OD regional |
| | drone or | regional or | drone or | drone or |
| | VS truck | conventional | VS truck | VS van |
| | | aircraft | | |

The system and methods disclosed herein orchestrate door-to-door transport across the local and long-distance legs, across modes and across the range of operator segments, such as fixed (FS) or variable schedules (VS), on-demand (OD) and shared services (mode and operator segment examples listed in Table 1). Several of these operate very differently to transport modes today. Table 4 contrasts the operating processes of conventional air today with regional air of the future, hybrid-electric, piloted or drone, STOL or VTOL.

System to Orchestrate Fast and Flexible Multi-Modal Transport

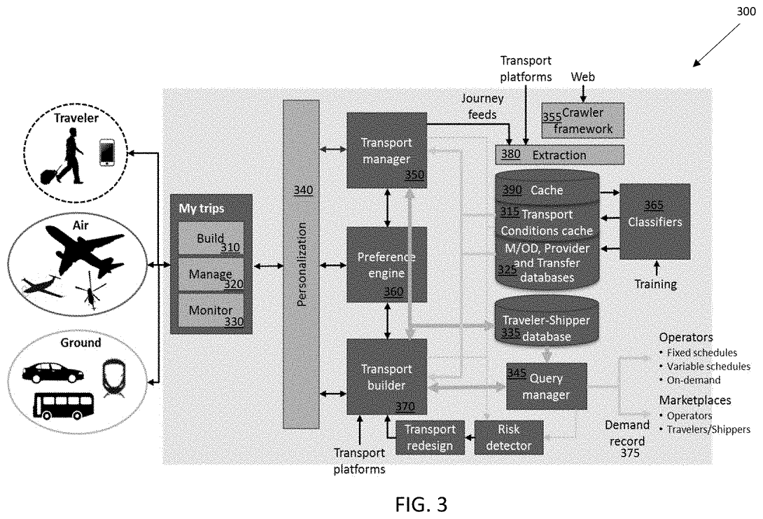

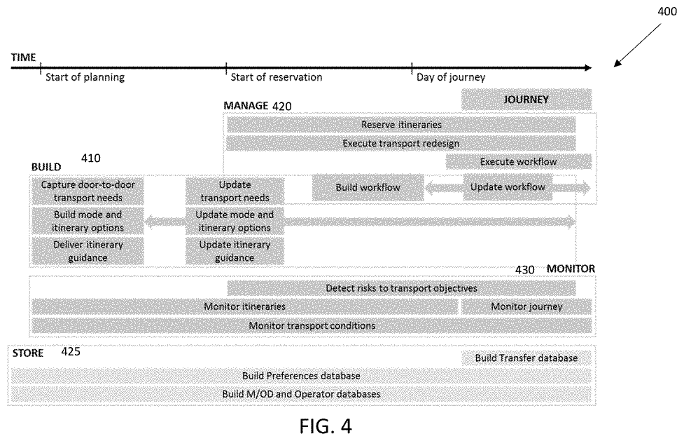

Trips are orchestrated door-to-door, across modes, segments and legs (as illustrated in FIG. 2) based on traveler Objectives and Preferences. FIG. 3 illustrates the architecture of the system that enables fast and flexible multi-modal travel, in accordance with some inventive aspects. FIG. 4 is an illustration of the sequence of procedures within the system that enables fast and flexible multi-modal transport, in accordance with some inventive aspects. As illustrated in FIG. 4, the function of each components are:
BUILD 410—Build candidate multi-modal transport options (e.g., optimal multi-modal transport options), over time, across changing supply and needs;
MANAGE 420—Manage key phases: reserve candidate itineraries (e.g., optimal itineraries), redesign to accommodate changes, execute workflow to orchestrate journey across operators and traveler;
MONITOR 430—Monitor itineraries, transport conditions and progress of the journey to detect risks or opportunities to transport objectives;
STORE 425—Store data on preferences, modes and origin-destination pairs, operators, platforms, marketplaces, transfer times.

TABLE 4

| Area | Current | Proposed |
|---|---|---|
| Check-in | At departure counter and | At departure gate or |
| | departure gate via printed | plane-side via device- |
| | tickets or smartphone scans | based (smartphone or |
| | | equivalent) or biometric |
| | | identification |
| Flight | Route set by standard | Determines optimal |
| planning | departure and arrival | flight trajectory and |
| | procedures required at | energy sourcing from |
| | large hubs, connected | hybrid powertrain over |
| | by direct (great-circle) | course of the flight. |
| | routing modified for high | Also determine optimal |
| | altitude winds and ATC | energy storage onboard |
| | restrictions. Narrow window | based on range, payload |
| | of efficient cruise altitudes | and recharging |
| | and airspeeds | capabilities at the |
| | | destination |
| Aircraft | On board pilot + co-pilot | By team of ground-based |
| piloting | (for more than 9 passengers), | pilots using remote |
| | responsible for all direct | piloting platforms as |
| | aircraft operations. Pilot | back-up to single |
| | tasks are primarily systems | onboard pilot or |
| | management, with manual | onboard autonomous |
| | operation in vicinity of | flight platform |
| | airports. Airlines utilize | |
| | remote dispatchers to monitor | |
| | flights, and make most of the | |
| | strategic decisions executed | |
| | by the pilots (e.g. abort to | |
| | alternate for weather). | |
| | Communication with | |
| | dispatch by voice and (limited) | |
| | data link. | |
| Refueling | Aircraft fueled for | Adds defined volume |
| | nominal mission plus | of fuel plus stored |
| | reserves. Additional | energy via recharge |
| | fuel may be taken on to | and swap, including |
| | avoid fueling at one of | addition or removal |
| | the destination stops | of storage capacity |
| | (to save time, or higher | to match optimal needs |
| | fuel costs at that terminal) | determined via flight |
| | | planning |
| Ground | Central dispatch monitors | Ground modes scheduled |
| coordination | flights and works to | to match flight departure |
| | preserve schedule across | and arrival times. Ground |
| | weather and equipment | arrival times broadcast |
| | delays. Schedule | to flight operator for |
| | responsibility to customer | real-time fine tuning |
| | starts and ends at the | |
| | boarding gate. | |

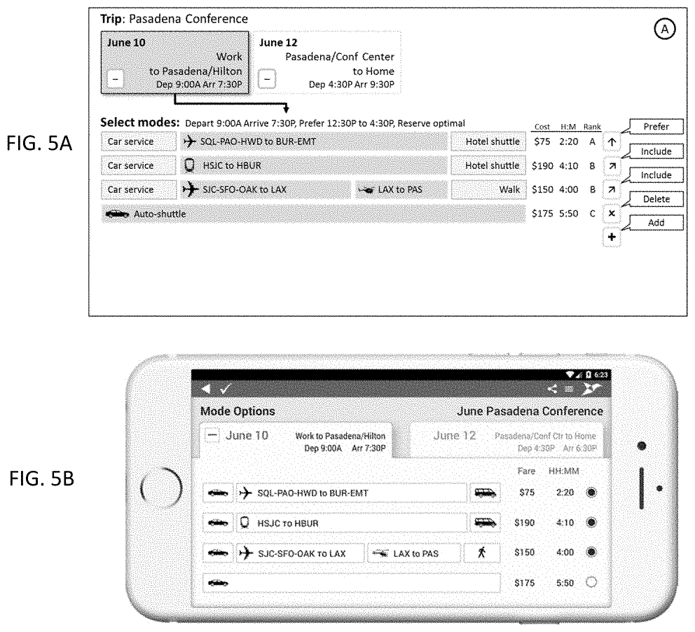

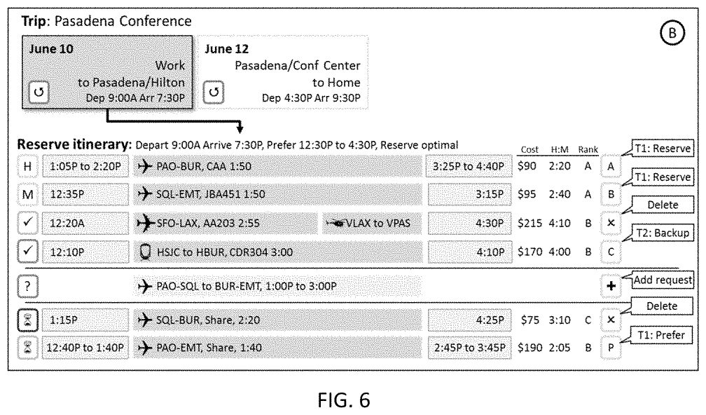

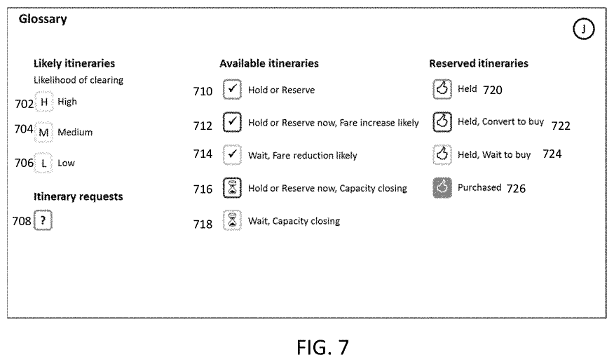

In some inventive aspects, traveler Preferences are built over time, via the personalization module 340 in FIG. 3, combining direct input from the traveler with deductions from past behavior of the traveler and others with similar characteristics. For instance, traveler preferences are populated capturing individual/user preferences based on user input and historical data comprising past behavior of the individual. In addition, traveler preferences also take into consideration global historical data comprising general trends of a trip captured based on data such as GPS data, weather data, and/or the like. Travel needs are captured for door-to-door trips comprised of multiple segments, each defined by Objectives and Preferences. Travel needs are met via a combination of specific and generalized itineraries and reservations that create flexibility and enable more efficient matching of supply to demand. Information on legs already reserved are uploaded, as are details that help define the Origin or Destination or the travel window such as reserved accommodations, bracketing events. Mode options for the journey are constructed from a Mode/Origin-Destination (M/OD) database 325 in FIG. 3, defining modes for each Origin-Destination pair, coupled with 3^{rd} party platforms for the local legs. For instance, FIG. 5A illustrates mode options for a generalized travel request from work in Palo Alto to Pasadena. These options are prioritized by the traveler or based on Preferences as illustrated in FIG. 5B. Itinerary options are generated for the reduced set of mode options by querying a wide range of operators, ranging from those with fixed or variable schedules, to on-demand or shared trip providers as illustrated in FIG. 6. Itineraries are ranked based on overall door-to-door Utility and other factors, and displayed for the traveler, including prompts to relax Objectives if the option set generated is insufficiently large. Options can be ranked by travel utility (Rank). In some inventive aspects, these options can also be sorted by door-to-door fare (Fare) or travel duration (H:M). For instance, as illustrated in FIG. 6, options include a generalized itinerary from PAO to BUR, or specific itineraries for SQL to EMT, SFO to LAX, HSJC to HBUR. Itineraries are sorted based on role in the reservation process: Tier 1, A, B and P above, followed by Tier 2, C below. Availability and guidance for each itinerary are indicated via symbols of the left (as illustrated in detail in FIG. 7). Options are available (marked with a tick) or have some likelihood of becoming available (marked H, M or L for High, Medium or Low). Options also include responses to a generalized request for a flight from PAO or SQL to BUR or EMT, which await selection into the option pool above.

The system then calculates a candidate window, such as, an optimal window, for reserving the trip based on fare outlooks for the selected modes, and proceeds based on traveler input on timing. Options are reduced to three tiers of tracked itineraries based on their Utility, or alternate metric preferred by the traveler, such that collectively they offer a high likelihood of generating a candidate trip (e.g., an optimal trip). The first tier is itineraries of superior Utility that are targeted for reservation at optimal fare levels. The second tier is itineraries of just lower Utility targeted as backup, and the third is itineraries with preferred schedules but uncompetitive fare levels, targeted for shift to the first tier if fares drop sufficiently.

A Timeline is built for each tracked itinerary reflecting a best forecast for the future journey across local and long-distance legs and personalized to the traveler. Timelines for the long-distance legs are loaded from the M/OD database with stages tailored to the adjacent local legs. Future times are determined by forecasting the duration of each stage based on operator input, or a Transfer outlook that estimates durations of individual transfer stages for a future arrival or departure. Timelines for the local legs are estimated from local platforms, similarly for the future arrival or departure.

Tracked itineraries are also tagged based on fare and capacity outlooks to provide guidance for reservation such as “Hold”, “Reserve now, fare increase likely” or “Wait, fare reduction likely”. Tracked itineraries are refreshed periodically to reflect changing fares or capacities. And itineraries are added or removed from the tracked list based on traveler input or automated prioritization. Itineraries are held or reserved by the traveler, or if automated reservation is selected, by the system.

Unlike the rigidity of transport today, the system is designed for a much more fluid future. To enable this, circumstances impacting the trip are monitored for change across external platforms. These include transport needs, itinerary options and transport conditions. Timelines for tracked itineraries are updated, and risk to transport objectives is assessed. If significant, transport needs and priorities are redesigned to accommodate and the build process is restarted. This process of building and redesigning itineraries may be repeated several times ahead of the journey, enabled by flexible business practices. The process continues during the journey as well, accommodating changes in travel needs, unexpected disruptions, or the availability of improved itineraries.

Ahead of travel, a workflow for the management of the journey is built, defining traveler and System actions based on Support level requested by the traveler and anchored to stages of the segment. Operator and Transfer management sequences, defined in the Operator and M/OD database respectively, are assigned based on Support levels. Also assigned to the Workflow are Notifications based on Preferences, as well as Transfer checklists. These pre-wire the traveler ahead of key stages of the journey, and provide simple checklists of documents required or actions to be taken. As the time for travel approaches, individual items on the Workflow are triggered, starting with the pre-travel Notifications. The System executes items assigned to it, notifying the traveler, while items assigned to the traveler or the operator may be triggered by the System and may include assistance by the System.

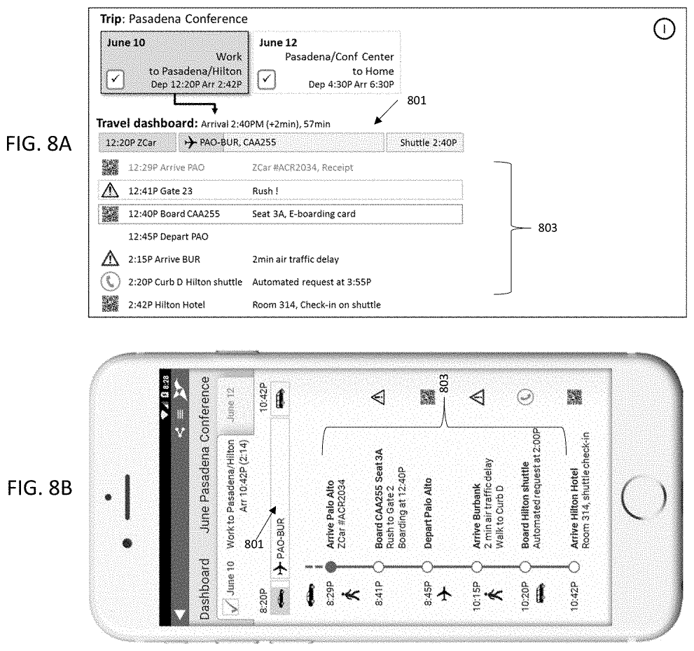

Once the journey is underway, progress of the traveler across modes is tracked via smartphone, vehicle location feeds, or other mechanisms. This is used along with travel conditions to continue refreshing itinerary Timelines, modifying Workflow execution to match. The system also uses the journey feed to build proprietary data around the duration of key transfer stages, such as time from airport parking to terminal, through terminal to gate, from gate to curb, from curb to rental car exit, immigration and customs. These are displayed in a convenient way for the traveler in a Travel dashboard as illustrated in FIG. 8A and FIG. 8B. The bar 801 shows departure and arrival times, travel time remaining, while the steps below 803 are items of the Workflow, refreshing periodically based on changes to the Timeline and progress towards the Destination.

The architecture and process flows shown on FIG. 3 and FIG. 4 are one aspect of the system as a standalone travel management platform. The system or components thereof can also be implemented in other of ways in conjunction with the range of travel planning or reservation platforms, operator platforms and marketplaces. For instance, elements of the system may be implemented within current travel platforms such as Expedia.com, Orbitz.com, operator platforms such as AmericanAirlines.com, travel management platforms such as Triplt.com, Mapping platforms such as Google Maps.

Method to Describe Door-to-Door Transport Needs Via Traveler or Shipper Objectives and Preferences

Unlike current approaches, focused on discrete legs or modes of a trip, the full extent of a traveler or shipper's door-to-door transport need is captured, including flexibility of the need and its changeability over time. Leverage of this inherent flexibility is critical to building a responsive transport system, unlike the rigidity of today. This equates to significant benefit for travelers or shippers and operators. For travelers, the system is much more responsive, given change requested by a traveler can be accommodated by adjustments of itineraries elsewhere. For operators, the same flex can be used to lift yield and revenue for operators, improving economics, or lift transport utility for customers, improving loyalty.

A trip is defined by the Objectives and Preferences of the traveler or shipper. Trips are described as a collection of segments (e.g., segment-origin 202 to destination 204 in FIG. 2), each comprised of discrete legs (e.g., leg 208a to leg 208e in FIG. 2), and each made of one or several stages. Legs are local or long-distance, and stages of a leg are either transfer or travel. Travel stages are those where primary transport occurs in a leg, while transfer stages take the traveler to or from the travel stage. Each segment is described by coordinates of its Origin and Destination, time windows for transport, and Preferences. Time windows for a segment may be defined via earliest departure and latest arrival times, and may include a preferred sub-window. Alternately, travelers may define a departure or arrival window or some combination thereof, such as, time widows disclosed in Table 5. The travel window for a segment may be defined using absolute times, or via link to future events in an electronic calendar or equivalent. Similarly, Origin and Destination may be defined using absolute coordinates, derived from Preferences (e.g., Home or Work addresses), or via links to future events or future locations in a calendar or equivalent. These may vary by time within the time window, based on linked calendar event, or based on traveler location accessed via smartphone or other means. Some or all legs of a segment may be defined to a degree via Preferences or given prior Reservations.

TABLE 5

| | | Applicable |
|---|---|---|
| Type | Time window | preferences |
| Departure | Depart between times A and B, | Earliest departure |
| window | with preferred sub-window a and b | A |
| | Depart after time A | |
| | Depart at A, or time window a and b | |
| Arrival | Arrive between times A and B, | Latest arrival A |
| window | with preferred sub-window a and b | |
| | Arrive before time B | |
| | Arrive at A, or time window a and b | |
| Travel | Depart after A and arrive before B, | Earliest departure |
| window | with preferred sub-window a and b | A |
| | | Latest arrival B |
| Immediate | Depart after now | Latest arrival A |

For example, Objectives of a future trip to Pasadena and a same-day trip to Tahoe are show in Table 6. The Pasadena trip includes time varying Origin from Preferences, Destination via a calendar link, a departure to arrival time window with preferred sub-window.

TABLE 6

| Type | Detail |
|---|---|
| Future | Trip: Pasadena June Conference |
| | Segment 1: June 10 |
| | Palo Alto/Home or Work (before or after 11:00A) to |
| | Pasadena/Hotel (Calendar) |
| | Window 9:00A to 7:30P, 1:00P to 4:30P preferred |
| | Segment 2: June 12 |
| | Pasadena/Conf Center (Calendar) to Home |
| | Window after lunch meeting (Calendar) to 10:00P, before |
| | 7:30P preferred |
| Immediate | Trip: Tahoe day trip |
| | Segment 1: Today |
| | Palo Alto/Home to Tahoe/Heavenly Mountain Resort |
| | Window Now (7:00A) to 9:00A |
| | Segment 2: Today |
| | Tahoe/Heavenly Mountain Resort to Palo Alto/Home |
| | Window 4:00P to 6:30P |

Preferences applicable to a segment are traveler or shipper Preferences modified by choices specific to the trip, segment or leg. Preferences may be described explicitly by the traveler or deduced from past behavior, or some combination thereof. Preferences may define modes, operators, Loyalty information, trade-offs such as cost-of-time for leisure or business, flexibility, reliability, travel times, connections, terminals. Choices specific to a trip may include factors such as purpose (business or recreation), modes, locations and times.

Objectives and Preferences defining a trip are changeable, in the weeks leading up to a trip, on the days of travel, or even after travel is underway. Changes may be triggered by the traveler or shipper, by events that define Objectives, by changing travel conditions or by changing itineraries.

Method to Use Generalized Transport Requests and Reservations for Flexibility

In order to extend the inherent flexibility of transport needs to the system, the methods disclosed herein go beyond conventional rigid itineraries and reservations that refer to specific departures from specific terminals. This is done via “generalized” versions that leave a few or many aspects of an itinerary open. Examples of use include generalized transport requests as way to query operators for itineraries that meet the traveler's or shipper's needs, generalized itineraries as way for operators to communicate available capacity, and generalized reservations whereby operators commit to offer services within parameters defined by the reservation.

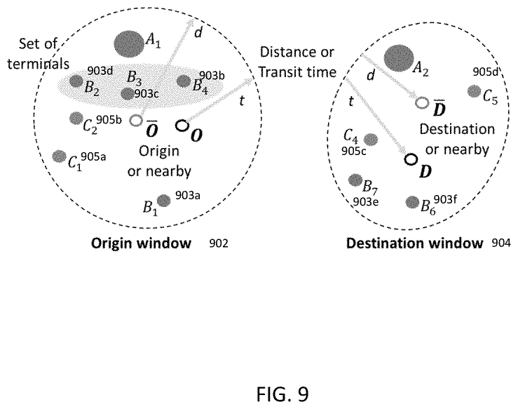

Specific transport requests define specific locations and times for a trip, along with select characteristics of the mode. Examples of specific requests are disclosed in Table 7. Specific itineraries and reservations, in addition, define the mode in full detail, for example, via connections, operators, equipment and comfort. In contrast, generalized transport requests leave location or time, or both, in generalized form, and couple these with select characteristics of the mode. Generalized itineraries and reservation are similar, but with added detail on the mode to enable the traveler or shipper make a transport decision. Generalized Origin, for instance, may be defined to within prescribed distance or transit time from the Origin or a Nearby location, or as a set of Departure terminals that are convenient for the traveler or shipper. FIG. 9 illustrates a number of ways in which Origin window 902 and Destination window 904 can be defined. In some inventive aspects, the origin window 902 and the destination window 904 can be defined by a pre-determined and/or user-defined radius and/or transit time. The origin window 902 includes departure terminals, such as, 903a-903d. In some inventive aspects, the origin window 902 can also include arrival terminals, such as, 905a and 905b that may be convenient for one or more travelers or shippers for a different segment of the same trip or a for a different trip. In a similar manner, the destination window 904 includes arrival terminals, such as, 905c and 905d. In some inventive aspects, the destination window 904 can also include departure terminals, such as, 903e and 903f. In this manner, a generalized descriptor can be built. Ahead of that, simple translators enable translation of location and time descriptors. For instance, a Departure windows defined at the Origin can be converted to a Departure window at a Departure Terminal by estimating durations of future local legs from the Origin to the Terminal at start and end of the window, and adding these to the Departure window to push to the Terminal.

TABLE 7

| | Location | Time | Mode |
|---|---|---|---|
| Specific | Origin or Nearby | Departure time | Connections, |
| | Destination or | Arrival time | Operator, |
| | Nearby | | Equipment and |
| | Departure terminal | | Comfort |
| | Arrival terminal | | |
| General- | Local transit time | Departure | Speed, e.g., High, |
| ized | or band e.g., | window | Medium, Low |
| | High, Medium, | Arrival window | Connections, e.g., |
| | Low | Departure to | Direct, # Stops |
| | Distance or band | Arrival window | Platform, e.g., Air, |
| | Set of Departure | Transit time | Rail, Bus |
| | terminals | | Operator |
| | Set of Arrival | | Comfort, e.g., |
| | terminals | | Premium, Economy |

Specific itineraries define end points, schedules and operators for each leg. Generalized itineraries balance the need of the traveler or shipper to have certainty around key aspects of the transport, against need of the operator to optimize schedules for improved yield. An example of specific an generalized travel requests and itineraries for a Palo Alto to Pasadena trip is disclosed in Table 8. A traveler seeking transport services defines these using a generalized form that specifies a travel window (departure, arrival or a combination), Origin and Destination. The latter may refer to specific locations and may vary based on time of travel or be set by real-time location of the traveler. This is converted to a generalized request for operators by identifying viable Departure and Arrival terminals, and calculating time windows for these based on durations of the local legs and transfer stages of the long-distance legs. The operator then returns with a generalized itinerary that specifies a travel window (departure, arrival or a combination), duration, class of service and fare, which the traveler chooses to reserves. Closer to travel, the operator finalizes service schedules and defines remaining detail on the generalized reservation to make it specific.

TABLE 8

| Type | Description | Example |
|---|---|---|
| Generalized | Traveler objectives | Segment: June 10 |
| request | reduced to travel | Palo Alto/Home or Work |
| | requests for each | (before or after 11:00A) |
| | segment option and for | to Pasadena/Hotel |
| | individual legs within | Window 9:00A to 7:30P, |
| | Generalization broad | 1:00P to 4:30P preferred. |
| | enough to capture wide | Leg A: Local flexible |
| | range of alternatives | Leg B: Regional flight |
| | | Leg C: Hotel shuttle |
| | | Leg B: SQL/PAO/HWD to |
| | | BUR/EMT flight Window |
| | | 9:20A to 7:10P, 1:20P |
| | | to 4:10P preferred |
| Generalized | Enables traveler to | Segment: June 10 |
| itinerary or | determine utility, while | Palo Alto/Work to |
| reservation | operator has ability to | Pasadena/Hotel |
| | flex | Window 12:45P to 4:00P |
| | Enables flex across | Duration |
| | routes, schedules and | 1:55, $175, Premium aisle |
| | equipment | seat |
| | Enables flex across | Leg B: SQL/PAO/HWD to |
| | schedules and equipment | BUR/EMT direct flight |
| | | Depart 1:00P to 2:20P |
| | | Duration 1:10, $160, |
| | | Premium aisle seat |
| | | Leg B: PAO to BUR direct |
| | | flight |
| | | Depart 1:00P to 2:20P |
| | | Duration 1:10, $160, |
| | | Premium aisle seat |
| Specific | Conventional itinerary | Segment: June 10 |
| Itinerary or | for a segment or | Palo Alto/Work to |
| reservation | individual legs defining | Pasadena/Hotel |
| | end-points, schedule, | Window 1:20P to 3:10P |
| | operators. | Duration 1:55, $175, |
| | | Premium aisle seat |
| | | Leg A: 1:20P ZCar |
| | | pickup to PAO |
| | | Leg B: 1:40P CAA214 |
| | | to BUR, seat 3B |
| | | Leg C: 2:50P Hilton |
| | | shuttle, arriving |
| | | 3:10P |
| | | Leg B: PAO to BUR |
| | | direct flight CAA214, |
| | | 1:40P to 2:40P |
| | | Duration 1:00, $160, |
| | | seat 3B |

Itineraries are tagged as reserved, held or Requested (or other similar categories). A reserved itinerary, specific or generalized, guarantees travel as described but comes with defined change processes for the traveler or shipper and operator. A held itinerary, specific or generalized, guarantees travel as described typically with limited time for conversion to reserved, but comes with fewer or no change penalties. A Requested itinerary, specific or generalized, describes travel services sought by a traveler. Alternate itineraries tracked include those tagged as preferred by a traveler, or those Offered by others and awaiting traveler response. Reserved, held and Requested itineraries may have additional descriptors, such as flexibility to change of a reserved itinerary, the likelihood of a held itinerary being reserved or the likelihood of an itinerary coming available.

To further improve responsiveness of the system, itineraries are changeable. Travelers or shippers are able change itineraries where capacity is available subject to fees. Change fees may be negotiated based on estimated or actual revenue impact on the operator. Alternately, novel change insurance or flexible reservations may allow no-fee changes in certain situations. Travelers and shippers may also trade itineraries with each other, subject to restrictions, on a barter, auction or fee basis. Operators may also change itineraries with traveler or shipper consent subject similarly to a change fee. The change fee may not apply and consent may be automatic for some changes, such as those that improve the Utility of transport. The fee may be established by auction, or determined based on the impact to the Utility of the traveler or shipper.

Methods to enable greater changeability of reservations include the following:
Variable change fees. Determine revenue impact of a change to determine fair fee or incentive.
   For instance, if change is from an itinerary with significant capacity (beyond a threshold) to another of equivalent capacity, revenue impact is zero. In other situations, impact equals fare of the old itinerary at the time of change plus any overbooking costs averted on the old departure, less fare of the new itinerary at the time of change, less any overbooking costs on the new departure.
Change insurance. Travelers are offered a travel insurance feature that covers the cost of a limited set of changes to similar class service for a fee. The feature is priced based on historical data on traveler change behavior and costs incurred as a result. The cost of delivering the service is reduced by negotiating change fees with operators, on individual transactions, and as block purchase, by identifying buyers for the released itineraries, and by finding low-cost exchange opportunities.
Flexible bookings. Travelers are offered reservations with defined levels of flexibility across modes. For instance, reservations for peak versus off-peak travel that allows change to available itineraries within the defined window.
Methods for travelers to share and trade transport. This may include transport offered to others on an on-demand reservation or on an owned vehicle, and the sale, purchase or exchange of reserved transport. This is enabled by several features of the inventive system. First, mediation by the system to ensure the transaction is legal and meets restrictions of any underlying reservation. This may entail identifying the transaction as a legitimate cancelation or change by identifying the traveler, reviewing the history of transactions by the traveler for signs of abnormality such as repetitive cancelations, tracking both sides of a change or exchange transaction. The system may also recommend “fair” compensation based on fare levels of any underlying reservation, prevailing fares on comparable modes. Second, by use of generalized transport records (described subsequently) to enable portable and secure transport matching across a wide range of platforms. Third, by use of transport pools as clearinghouses for generalized transport records. These match records within the pool, transport offered with transport required, offer secure communication for counterparties with matched records to share detail, and secure transaction to minimize risk of misrepresentation and illegality.

Method to Use Generalized Records for Extended Transport Clearing

Generalized descriptors are also used to enable broad matching of transport supply with demand that goes far beyond capacity offered by primary operators. This extends to excess or distressed inventory of primary operators, capacity available at long-tail operators, excess or unused capacity with travelers or shippers, among others.

This is enabled via a specific or generalized transport record that is designed for portability and security. The record is a reduced and sanitized description of transport demand or available capacity that enables first-level matching. Sensitive information is kept secure till later in the matching process. For instance, elements that identify the traveler, shipper or operator may be disguised. Origin and Destination are replaced by Nearby locations or Location windows. Identifiers are replaced with links to enable second-level matching and transaction within secure marketplaces or clearing platforms.

Demand records define generalized Origin and Destination and travel windows, appropriately disguised. In addition, the records may include mode preferences, fare targets, reserved or preferred itineraries. Supply records define specific or generalized Origin and Destination and travel windows. They include detail on mode, fare basis, and capacity.

Method to Identify Itinerary Options that Maximize Door-to-Door Utility

A key function of the BUILD element (e.g., Build 310 in FIG. 3 and BUILD 410 in FIG. 4) of the system disclosed herein is generating itineraries that optimally meet the traveler's or shipper's Objectives and Preferences for each segment of a trip. Unlike conventional platforms, the itineraries generated are door-to-door, across local and long-distance legs. They are also multi-modal and include services from a variety of operators offering fixed or variable schedules, on-demand and shared services, versus split today by mode and operator business model. The method and systems disclosed herein also enables travelers and shippers to collaborate to meet their transport needs.

In some inventive aspects, the method disclosed herein uses a number of metrics to prioritize itineraries. Key among these is a measure of the Utility of an itinerary tailored to the traveler or shipper. Other metrics used in the prioritization process include trip duration, Total fare, Departure and Arrival times, Reliability. The Utility of an itinerary equals a measure of the benefit less a measure of the cost. The benefit and cost measures are tailored to the traveler or shipper via Preferences. The benefit measure equals a composite of factors such as mode preference, transfer quality, comfort, loyalty program benefits, safety and reliability. Costs are the sum of direct costs, incidentals, environmental costs, and cost of time. Direct costs include fares, rental fees, parking, fuel, insurance, depreciation, tolls. Incidentals include food, accommodation incurred along the way. Environmental impact includes the cost of greenhouse gas emissions, community noise, among others. Cost of time equals a unit cost of time for the travel or shipper (may vary by type of trip, business or recreation) multiplied by duration and adjusted for factors such as increased productivity on some modes relative to others.

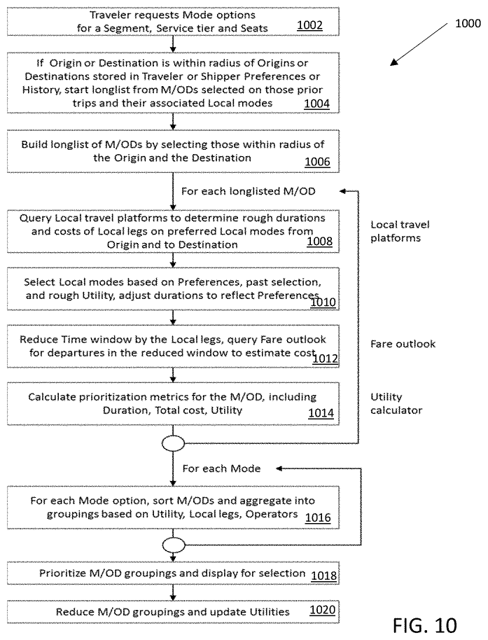

Segments are constructed to meet traveler or shipper Objectives by building on any pre-booked legs to complete the journey. Viable long-distance modes are identified in the vicinity of start and end points of undefined legs using a Mode/Origin-Destination database. Table 9 discloses an example Mode/Origin-Destination database. The Mode/Origin-Destination database is a library of transport options by Origin-Destination pair. Mode options are built by defining specific modes for each long-distance leg as further illustrated in FIG. 10.

Metrics such as trip duration, total fare and Utility are calculated for each segment option to enable prioritization by the system and the traveler or shipper. Modes options are displayed by leg in a table or on a map, enabling the traveler or shipper to prioritize options, add new ones, or define modes for local legs. FIG. 5A and FIG. 5B show mode options for generalized travel from Palo Alto to Pasadena.

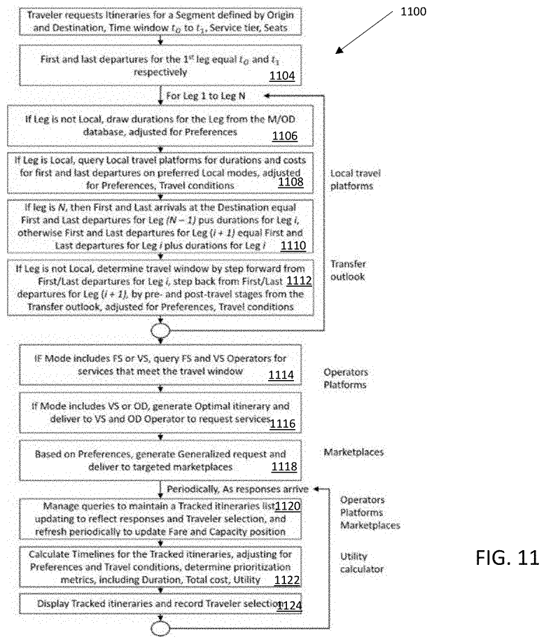

For each shortlisted mode option determined in FIG. 10, queries are launched to identify candidate Itineraries for the long-distance leg as further illustrated in FIG. 11. Queries target fixed or variable schedule and on-demand operators serving that Mode/Origin-Destination. Fixed and variable schedule operators are queried for all Itineraries that meet Objectives for each leg. Variable schedule and on-demand operators are sent generalized transport requests. A generalized transport record may also be broadcast to a range of marketplaces to access off-inventory, long-tail or traveler- and shipper-offered Itineraries.

TABLE 9

| Variable | Detail |
|---|---|
| Traffic | Passenger volumes and seasonal variation |
| Segments | Major operator segments, distinguished by their |
| | business practices |
| Service tiers | Major classes of transport offering, e.g., economy |
| | versus business class, turboprop versus jet aircraft |
| Duration | Average terminal to terminal travel time, including |
| | drilldown by service tier (includes transfers) |
| Fares | Average terminal to terminal fares, including |
| | drilldown by service tier |
| Safety and | Metrics tracking safety and reliability of the |
| reliability | mode, for the Origin-Destination pair or drawn |
| | from a broader average. |
| Environmental | Metrics tracking GHG emissions, external noise, |
| impact | other impact per passenger, for the Origin-Destination |
| | pair specifically or drawn from a broader average. |
| Comfort | Metrics tracking passenger comfort relative to |
| | other modes, for the Origin-Destination pair or |
| | drawn from a broader average. |
| Operators | Links to operators serving the Origin-Destination |
| | in the Operators database |
| Platforms | Links to transport platforms serving the Origin- |
| | destination in the Platforms database |
| Marketplaces | Links to transport aggregators serving the Origin- |
| | Destination in the Aggregators database |
| Fares | Link to recent fares in the Fares cache |
| | Link to Historical fares in the Fares database |
| Local modes | Modes: VS and OD, Public |
| | Links to operators in the Local database |
| | Links to transit platforms in the Local database |
| Management | Workflow actions by stage of the leg with times |
| sequence | relative to stage times, along with assignments |
| | to Platform, traveler and operator based on |
| | Service level |
| Transport | Reminders and guides to assist the traveler to |
| checklists | include in Notifications and key stages of the leg |

Queries return specific or generalized itineraries, along with their availability or likelihood of becoming available and fares. Some responses are immediate, others arrive over time. Fixed schedule operators add capacity, variable schedule operators modify schedules, spare capacity on on-demand services is offered to others, and travelers or shipper with changed needs offer their Itineraries to others. In addition, capacity and fares of Itineraries change over time as inventory positions change and fares are adjusted to optimize revenue.

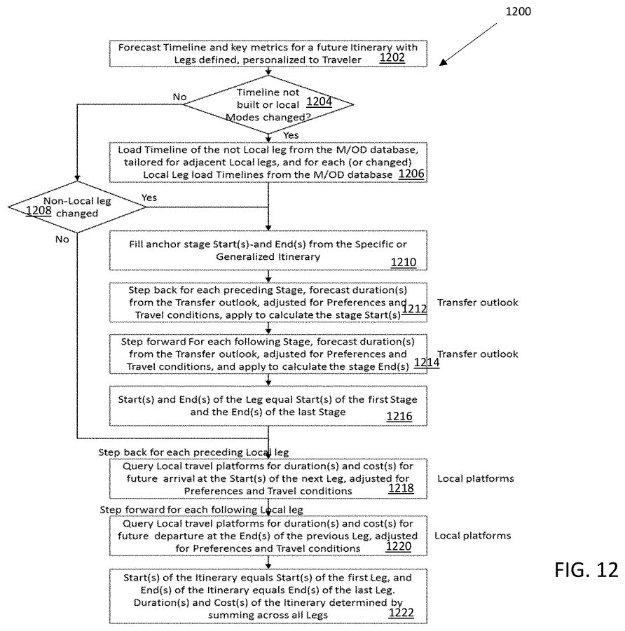

Travel Objectives and Preferences are assessed to see if they lead to a sufficiently large option set. If not, additional itineraries are generated by relaxing Objective, and added to the option set pending approval. Timelines and key metrics are determined for each itinerary option as further illustrated in FIG. 12, and tagged based on availability or likelihood of becoming available and other comparison metrics. Open itinerary requests are marked separately, along with responses to these requests pending traveler or shipper prioritization. FIG. 6 shows itinerary options for the Palo Alto to Pasadena segment.

Method to Assist with the Optimal Reservation of Multi-Modal Transport

Another function of the BUILD element (e.g., Build 310 in FIG. 3 and BUILD 410 in FIG. 4) of the system disclosed herein is reservation of Itineraries that optimally meet traveler or shipper Objectives and Preferences for each segment. Unlike conventional platforms, reservations are made across modes and across a variety of operators offering fixed or variable schedules, on-demand and shared services. Moreover, itineraries are reserved in a way that continually optimizes transport across changing supply, transport conditions and transport needs, versus rigid bookings today, leveraging the increased flexibility of the transport system.

An important element of this capability is decision support to the traveler or shipper. This is offered at two levels. First is decision support for the candidate reservation (e.g., optimal reservation) of itineraries from an operator or a class of operators serving a mode, for example, conventional air operators offering fixed schedules. Second is decision support for reservations across itineraries from multiple modes, or multiple classes of operators of a mode.

The first is a significant challenge today given aggressive revenue management practices resulting in fares on an itinerary varying on average by a multiple of 3.2 from low to high. Fares typically drop over 30 to 120 day windows ahead of a flight, then increase sharply at the 21, 14 and 7 day marks. And patterns vary widely based on competition, available capacity, day of the week, business versus leisure mix. These aspects of revenue management can extend to regional transport (e.g., regional air). However, the unique environment can drive significant change. Operators may face several other modes with distinct cost structures (e.g., highways, regional air, conventional air, high-speed rail). Competitive dynamics may be reshaped by the distributed nature of regional air versus the concentrated hub network today. Moreover, the much greater need for flexibility on regional trips can limit the ability of operators to vary fares as widely as they do today.

Given the uncertainty around future revenue management practices, the methods and systems disclosed herein are based on a targeted set of capabilities that can be tuned to a wide range of processes. Elements of these may also be sourced from 3rd party platforms where these offer more robust solutions. The first of these capabilities are methods to estimate a candidate reservation window (e.g., an optimal reservation window) for an operator or a class of operators given the likely variation of fares to departure. The candidate reservation window is selected to maximize the likelihood of fares lower than current, less the likelihood of fares higher than current. One approach is to determine this from the probability distribution of normalized fares by days to departure and available capacity for the Mode/Origin-Destination. The latter is determined from historical fare and capacity data, derived from models of revenue management practices, or some combination of the two. Another approach is to determine candidate windows from models for normalized fares by days to departure and capacity for the Mode/Origin-destination, based on revenue management practices and historical fare data. Yet another approach leverages machine learning to factor a broader set of variables, including fare levels on competing modes, to determine the candidate window.

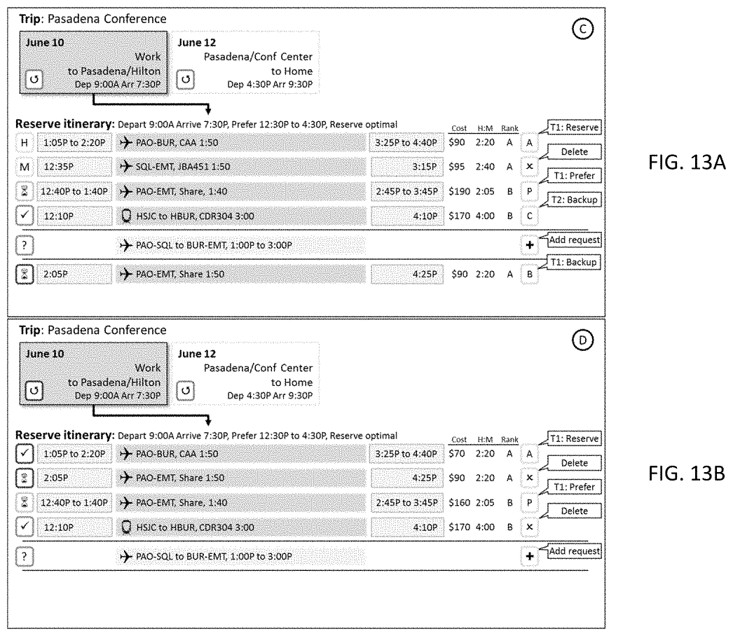

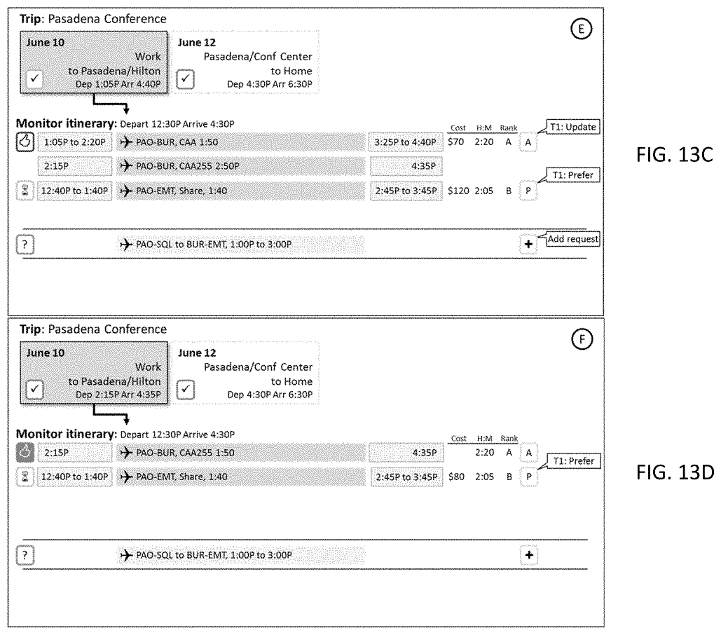

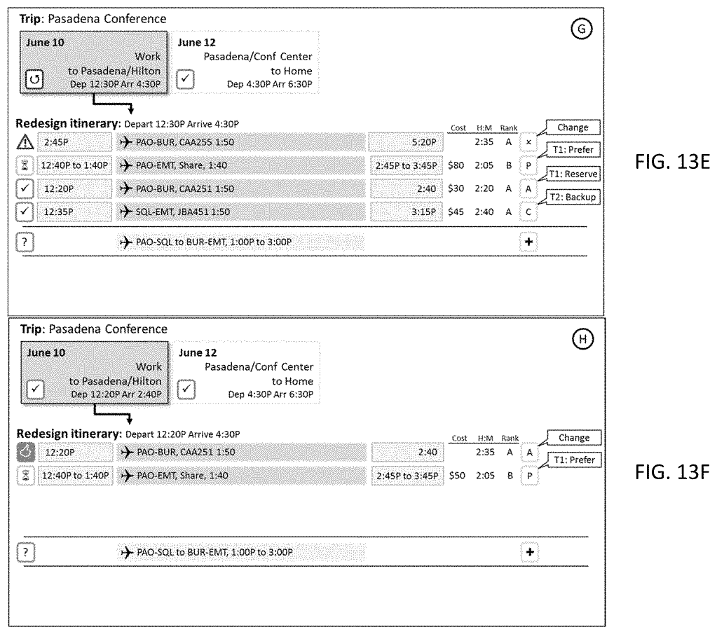

The second of the capabilities are methods to determine fare outlooks for an itinerary. These, coupled with capacity feeds from operators and Platforms, create a robust basis for reservation decisions (referred to as “fare outlook” in the following). On the one hand, assessing optimality of a fare based on likelihood of a lower fare becoming available for the itinerary, on the other, monitoring capacity levels to ensure preferred itineraries remain available. One approach uses machine learning to forecast fares based on historical fare and capacity data, and applies it to recent fare and capacities to arrive at assessments. All of these may be supplemented by heuristics that model revenue management practices, e.g., current airline approach to raise fares at 21, 14 and 7 days. These enable recommendations for the specific itinerary, such as “Reserve” (e.g., Hold or Reserve 710 in FIG. 7) for fares that are assessed as optimal, “Reserve now, fare increase likely” (e.g., 712 in FIG. 7) if the optimal fare is assessed as likely to increase, “Reserve now, Capacity closing” (e.g., 716 in FIG. 7) if capacity levels are low, or “Wait, fare reduction likely” (e.g., 714 in FIG. 7) if the fare is assessed as sub-optimal and with sufficient capacity available. FIGS. 13A-13F illustrate Itinerary options for sample Palo Alto to Pasadena trip evolving over time to the final reserved itinerary in FIG. 13F.

Given changeability of travel needs and itineraries, reservation recommendations are based on Utilities adjusted for the greater option value of itineraries subject to lower rather than higher change penalties. To do this, the systems and methods disclosed herein add to Utility a measure of the benefit of reserving (or holding) an itinerary as the difference of the likelihood a better itinerary will not be offered times the delta in Utility of the itinerary from poorer alternatives, less the likelihood a better itinerary will be offered times the delta in Utility of the better itinerary to that being reserved. The probabilities and Utilities are derived from a combination of fare histories and recent fare trajectories using techniques similar to those described to calculate candidate reservation windows (e.g., optimal reservation windows) and fare outlooks described previously. The cost of this benefit is accounted for reducing the Utility by an amount equal to the total cost incurred when changing the itinerary times the likelihood the better itinerary will be offered. Costs include change penalties or hold fees, but may also include an allocated cost of change insurance if purchased for flexibility on the trip.

Leveraging these capabilities, the platform determines a candidate window for reserving the trip based on the prioritized modes, their relative traffic and utilities. This is determined by maximizing the weighted likelihood of fares lower than the current, less the weighted likelihood of fares higher than current, across the highest Utility modes. Weighting is by a combination of the relative traffic and Utilities of the modes, unless otherwise specified by the traveler or shipper. This is displayed as guide which the traveler or shipper may accept as Reservation timeline, or respond with alternatives such as “Now” for same-day reservation or “By date” for reservation by the provided date. The traveler or shipper may also provide a fare target for outreach to operators, to guide itinerary notifications or itinerary reservation.

To support decisions across modes and operators, itineraries for the shortlisted modes are split into tiers based on Utility or other metric preferred by the traveler. The first tier includes the highest utility itineraries that collectively have a high likelihood of clearing. These are targeted for “Hold” or “Reserve” as they become available at optimal fares. The second tier are back-up itineraries, targeted for upgrade to Tier 1 in event the risk of Tier 1 not clearing becomes high. These may include a highly available mode (e.g., own vehicle) for searches where a traveler of shipper seeks alternatives only if aggressive fare targets are met. The third tier includes itineraries marked by the traveler or shipper as preferred given Utility comparable to Tier 1 if fares were to drop. FIG. 6 shows tracked itineraries for a Palo Alto to Pasadena trip tiered as described.

These three tiers of tracked itineraries and their comparable alternatives, including itinerary requests, are refreshed periodically. This includes real-time monitoring of fares and capacities, assessment of fare and capacity outlooks based on reservation timeline, refresh of Timelines and a recalculation of Utilities given changing fares. The itineraries are then resorted and tagged for display to guide reservation. The tags are some combination of labels, colors and symbols that are designed to communicate the fare and capacity outlook in a compact way, such as “Reserve now, fare likely to increase” (e.g., 712 in FIG. 7) for optimal fares that are likely to increase or if capacity is low, “Reserve now” (e.g., 710 in FIG. 7) for optimal fares with adequate capacity, low likelihood of increase, “Wait, fares likely to decrease” (e.g., 714 in FIG. 7) for sub-optimal fares with adequate capacity, “Wait, Capacity closing” (e.g., 718 in FIG. 7) for sub-optimal fares where capacity is low. A sample glossary defining symbols used to communicate itinerary status is illustrated in FIG. 7.

The reservation process, once initiated, continues through the end of travel for the segment, but with varying objectives. FIGS. 13A-13D display tracked itineraries evolving based on fares, capacity and traveler or platform prioritization:
Initiation to first reservation. Tracked itineraries are refreshed periodically and the list is updated to reflect new itinerary options and responses to itinerary requests.
First reservation to arrival at destination. Tracked itineraries are reduced to a subset with Utility, adjusted for the cost of change, competitive with the reserved itinerary. These are refreshed periodically, and the list is updated to reflect new itinerary options and responses to itinerary requests.

The platform executes to guidance automatically if “Managed” reservation is selected, and guides the traveler or shipper through execution in event of “Assisted.”

Method to Manage Multi-Modal Journeys in Real-Time

A key function of the MANAGE element (e.g., Manage 320 in FIG. 3 and MANAGE 420 in FIG. 4) of the system disclosed herein is the seamless orchestration of multi-modal journeys in real-time, based on Service level requested: None, Assist or Manage. This is done via predefined management sequences tailored to mode and O/D, stored in the Operator and M/OD databases, anchored in time to stages of the associated leg. Preceding these management sequences are pre-travel Notifications that are determined by traveler or shipper Preferences. And these are coupled with Transfer checklists to assist with transfer through terminals, stored in the M/OD databases, similarly anchored to pre-travel Notification or stages of the associated leg.

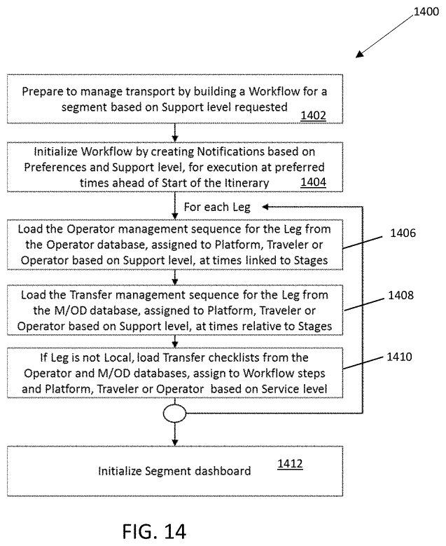

A day or more ahead of travel, determined by Preferences, the Timeline for the reserved itinerary is refreshed as illustrated in FIG. 12. The Workflow corresponding to the itinerary is then built as illustrated in FIG. 14 by first creating the pre-transport Notification from Preferences for execution at a defined preferred time ahead of Start of the itinerary. The Workflow for each leg is then built by loading Operating and Transfer management sequences for the leg from the Operator and M/OD databases, respectively, split by Platform or traveler based on Service level requested. These are supplement by Transfer checklists are loaded from the M/OD database, which are assigned to Workflow, split by Platform or traveler based on Service level.

Timelines continue to be refreshed periodically to reflect changes in itineraries and transport conditions. Once the Journey starts real-time feeds on progress, via smartphone or other device, from operator platforms, trigger further updates as illustrated in FIG. 12. Changes to the Timelines, including changes to transport needs, are assessed for risk or opportunity to traveler Objectives, and if required, trigger a redesign of the segment with traveler or shipper direction.

TABLE 10

| | Stages | Timeline | Traveler | Platform |
|---|---|---|---|---|
| 0 | Notify | T1A- | Confirm start of | Notify travel of pickup time and location, |
| | traveler | traveler | segment | receive confirmation |
| | | notification | | |
| 1 | Request Zcar | T1A - Zcar | Receive Zcar | Request Zcar with pickup and |
| | | arrival | details | drop locations |
| | | | | Receive Zcar ETA and notify |
| | | | | traveler of pickup details |
| 1A | Pickup by | T1A | Receive flight | Confirm Zcar pickup |
| | Zcar | | details | Notify traveler of flight details |
| | | | | Send operator traveler ETA |
| 1B | Curbside drop | T1B | Approve Zcar | Confirm Zcar drop |
| | | | invoice | |
| 2A | Curbside drop | T2A | | |
| 2B | Arrive at | T2B | | |
| | airport | | | |
| 2D | Arrive at Gate | T2C | | Confirm arrival at gate |
| 2D | Flight | T2D | | Confirm flight departure |
| | departure | | | Received flight arrival details |
| 2E | Flight arrival | T2E | Receive shuttle | Confirm flight arrival |
| | | | details | Notify traveler of shuttle ETA |
| | | | Receive baggage | and pickup details |
| | | | details | |
| 2F | Arrive at Curb | T2F | | Confirm curb arrival |
| | | | | Inform shuttle |
| 3 | Request | T3B - | | Request shuttle pickup with |
| | Shuttle | Shuttle | | traveler and gate details |
| | | request | | Receive shuttle details |
| 3A | Arrive at Curb | T3A | | Confirm curb arrival |
| | | | | Inform shuttle |
| 3B | Pickup by | T3B | Receive hotel | Confirm shuttle pickup |
| | Shuttle | | booking details | Notify traveler of hotel booking |
| 3C | Drop at Hotel | T3C | | Confirm hotel arrival |
| | | | | Close segment |

TABLE 11

| | Stages | Timeline | Sources to monitor |
|---|---|---|---|
| 0 | Notify traveler | T1A - traveler | Traveler notification from preferences |
| | | notification | |
| 1 | Request Zcar | T1A - Zcar arrival | Future arrival time from operator platform |
| 1A | Pickup by | T1A = T1B - Airport | Future drive time from local travel platform |
| | Zcar | drive | |
| 1B | Curbside drop | T1B = T2A | |
| 2A | Curbside drop | T2A = T2B - Walk from | Future walk from curb from Transfer |
| | | curb | database |
| 2B | Arrive at | T2B = T2C - Airport | Future airport transfer from Transfer |
| | airport | departure transfer | database |
| 2C | Arrive at Gate | T2C = Flight boarding | Flight boarding time and gate from operator |
| | | | platform |
| 2D | Depart | T2D = Flight departure | Flight departure time from operator platform |
| 2E | Arrive at Gate | T2E = Flight arrival | Flight arrival time and gate from operator |
| | | | platform |
| 2F | Arrive at Curb | T2F = T2E + Airport | Future airport transfer and baggage delay |
| | | arrival transfer + Baggage | from Transfer database |
| | | delay | |
| 3 | Request | T2F - Shuttle request | Shuttle request from M/OD database |
| | Shuttle | | |
| 3A | Arrive at Curb | T3A = T2F | |
| 3B | Pickup by | T3B | Shuttle arrival from hotel platform or from |
| | Shuttle | | shuttle frequency in Transfer database |
| 3C | Drop at Hotel | T3B + Drive to hotel | Future drive time from local travel platform |

As progress along the Timeline triggers items in the Workflow, starting with pre-travel Notifications, those assigned to the Platform are executed, followed by updates to the traveler or operator based on Workflow. On other items, the role of the Platform is limited to providing assistance, monitoring execution and delivering notifications, varying based on Service level requested. Workflow for segment from Palo Alto to Pasadena comprised of three legs is shown in Table 10, with detail on anchoring of the Workflow to the Timeline in Table 11, and a sample Travel dashboard in FIG. 8A-8B.

Method to Detect Risks or Opportunities to Travel Objectives, Execute Redesign

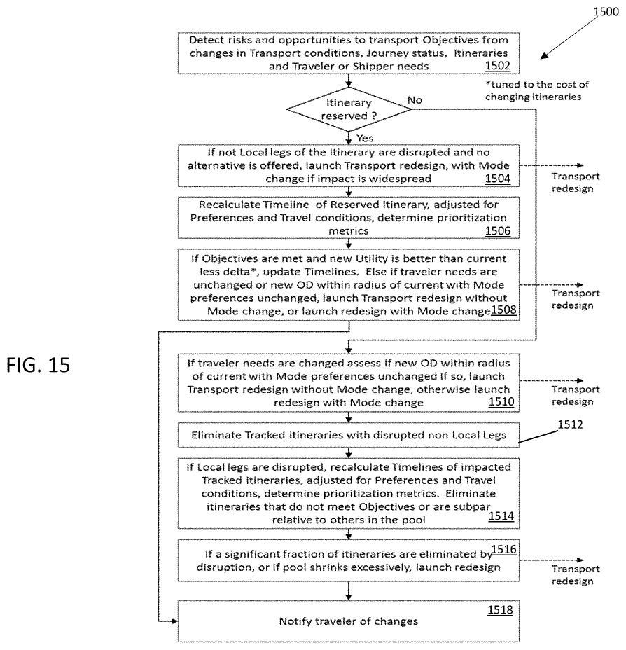

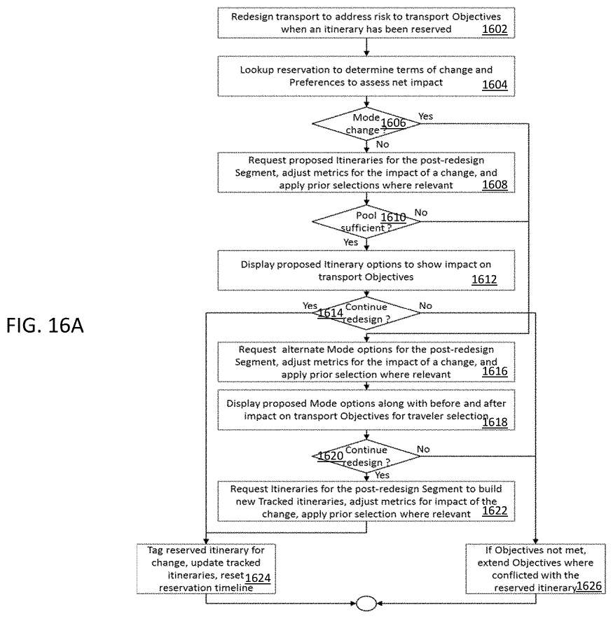

A key function of the MONITOR element (e.g., Monitor 330 in FIG. 3 and MONITOR 430 in FIG. 4) of the system disclosed herein is the identification of risks to travel objectives, and if a risk is assessed, the launch of process to redesign transport to remedy. This is done via ongoing monitoring of a range of conditions that impact the trip. Conditions monitored include traveler needs such as origin and destination or the travel window, transport status via operators of the local and long-distance legs, travel conditions with material impact on legs of the journey, e.g., weather, traffic, events. Significant change in these conditions triggers a risk detection process as illustrated in FIG. 15 to assess impact on traveler objectives and utility, and to determine if a redesign is required. If a redesign is not required, given objectives are met without significant degradation of utility, Timelines are updated and the traveler is notified. Otherwise a redesign is triggered with scope from full (modes and itineraries) to partial (itineraries) determined by the nature of risk.

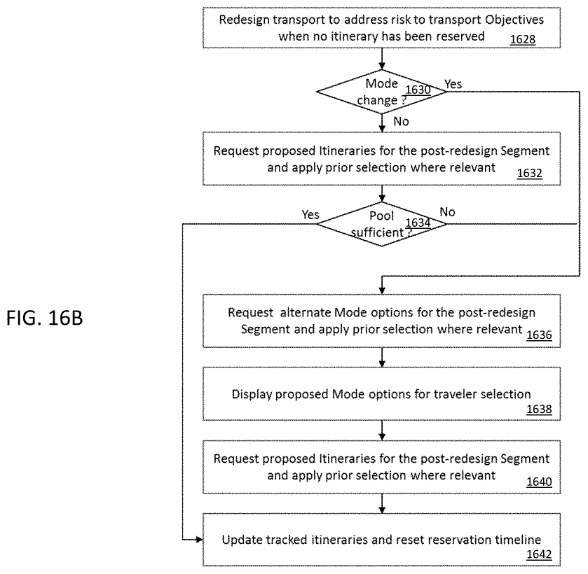

Redesign is a key function of the BUILD element (e.g., Build 310 in FIG. 3 and BUILD 410 in FIG. 4) of the system disclosed herein, and restarts build of a trip, full or partial, when risk is assessed as sufficient. FIG. 16A shows the flowchart for redesign when an itinerary has been reserved and FIG. 16B for redesign when no itinerary has been reserved. When an itinerary has already been reserved, fares and utilities of post-redesign itineraries are adjusted to reflect the terms of the existing reservation. For instance, where cancelation generates a refund equaling the original fare less a cancelation penalty, the fares of itinerary alternatives equal the new fare less old plus the penalty. The process generates post-redesign modes (full) or itineraries (partial) and presents them to the traveler for decision on whether to proceed with the redesign. If a redesign is selected, tracked itineraries are updated to post-redesign options, adjusted to reflect prior selections where relevant. The reservation process then continues as before to reserve a new candidate itinerary (e.g., an optimal itinerary). Unless directed otherwise by the traveler, the prior reservation is canceled in conjunction with a hold or reservation of an alternate itinerary.

Method to Determine Door-to-Door Itineraries Options for a Future Journey

An important element of the system and methods disclosed herein is bridging a traveler's door-to-door transport need to the terminal to terminal transport offered by most operators. This is done by translating traveler objectives at the Origin O and Destination D, to a time window that applies at the departure and arrival terminals of the chosen long-distance leg. For example, consider objectives that require departing O after t_{O} and arriving at D before t_{D}, for a 3-leg segment: local; long-distance; and local. First departure t₂ for long-distance leg 2 is calculated by querying local platforms for duration of the local leg 1 for future travel at t_{O} from D to the departures terminal, adjusted for preferences, travel conditions. Similarly, last departure t₃ for leg 3 is calculated by querying local platforms for duration of the leg for future travel from the arrival terminal to D, arriving at t_{D}, adjusted for preferences, travel conditions. The times t₂ and t₃ bracket the long-distance leg 2. These are tightened further to account for the pre- and post-travel stages. Stepping forward from t₂, the duration of each future pre-travel stage is calculated using the transit database. This determines the first departure time for the long-distance mode. Similarly, stepping backward from t₃, the duration of each future post-travel stage is calculated using the transit database. This determines the last arrival time for the long-distance mode. This pair, first departure and last arrival for the long-distance mode, is then used to identify itinerary options.

Methods for Multi-Modal Transport Monitoring and Forecasting

A function of the MONITOR element (e.g., Monitor 330 in FIG. 3 and MONITOR 430 in FIG. 4) of the system disclosed herein is tracking the progress of a journey to enable accurate updates of the Timeline. This is done by monitoring operator platforms for the status of the current stage (e.g., estimated time of arrival of a flight), or by monitoring the location of the traveler via GPS or other signal on the traveler's smartphone or similar device, or by manual entry by the traveler. When either of these deviate significantly from values expected given the current Timeline, a refresh is performed to align the forecast journey with that underway.

Another function of the MONITOR element (e.g., Monitor 330 in FIG. 3 and MONITOR 430 in FIG. 4) of the system disclosed is the building of a Transfer database to enable forecasting of the pre- and post-travel stages of each M/OD option. Accordingly, for each M/OD option, the Transfer database maintains durations for all pre- and post-travel stages. For instance, for conventional air as Mode, the database includes durations from local mode to Origin airport, through airport to gate without checked baggage, through airport to gate with checked baggage, from gate at Destination airport to exit with checked baggage, from gate to exit without checked baggage, from exit to local mode. Table 12 discloses example of pre- and post-travel stages stored in a Transfer database. Durations stored are averages with measures of variability where the variability is unstructured, or averages with a measure of variability at anchor points that capture the structure of the variability (e.g., by time of day and day of week, seasonal or holidays).

TABLE 12

| Type | Sample transfer times |
|---|---|
| Air | Parking, Rental drop, Public transit, Curbside drop etc. to |
| | Airport departures |
| | Airport departures to gate, with or without checked baggage, |
| | with or without priority |
| | Departures and Arrivals immigration and customs |
| | Arrival gate to Airport arrivals with or without checked |
| | baggage |
| | Airport arrivals to Parking exit, Rental exit, Public transit or |
| | Curbside pickup |
| High- | Parking, Rental drop, Public transit, Curbside drop etc. to |
| speed | Terminal departures |
| rail | Departures to platform with or without priority |
| | Terminals arrivals to Parking exit, Rental exit, Public transit |
| | or Curbside pickup |

The Transfer database is built and maintained in several ways. One by tracking a large number of individual journeys as described earlier, for instance, via smartphones with high-precision location capabilities such as advanced GPS or camera-based positioning. Second, by monitoring stage duration feeds from operators or terminal facilities. In both cases, the raw data is maintained in a cache for processing to the structured statistics that are then stored in the Transfer database.

Another function of the MONITOR element (e.g., Monitor 330 in FIG. 3 and MONITOR 430 in FIG. 4) of the inventive system is tracking conditions that have historically correlated to abnormal transfer (e.g., through airport to gate) or travel stages (e.g., local or long-distance modes) performance. These range from the timing of holidays and events, to extreme weather, infrastructure issues and labor action. Adjustments are applied to impacted transfer or travel stages to account for the likelihood of disruption, modifying Timelines and itineraries in response.

Forecast duration for a transfer stage is then determined by a transfer outlook function, drawing on the Transfer database and its supporting cache. For forecasts more than a few days ahead of travel the function calculates future durations based on historical averages stored in the Transfer database. These are modified using the stored variance to reflect the speed and risk tolerance of the traveler from preferences. These are set based on a combination of traveler behavior and stated preference. For forecasts close to the day of travel, the historical averages and variances are adjusted based on recent duration feeds in the cache and travel conditions, to increasing degrees based on proximity to time of travel.

Methods to Optimize Supply to Changing Transport Demand

The capture of door-to-door travel needs and the use of demand records enable operators to optimize their capacity based on evolving demand in ways not possible in the rigid long-distance transport systems of today. Examples for air operators include, optimizing supply and refining itineraries for reserved, held and requesting travelers, leveraging visibility to their door-to-door travel needs. Table 13 discloses range of opportunities to optimize supply by operator type created by the flexible transport system disclosed herein. Operators may trigger updates to traveler itineraries due to schedule changes or delays. Operators may upgrade travelers to improve itineraries or accommodate itinerary requests. Operators may offer to downgrade travelers to less preferred itineraries. Operators may alter schedules and equipment to better match demand leveraging segment flexibility. The capability also enables operators to collaborate to optimize supply to collective demand based on travelers end-to-end needs, or to respond jointly to abnormal events in ways to minimize adverse impact to travelers.

TABLE 13

| | |
|---|---|
| Type | Description |

FIXED SCHEDULES

| | |
|---|---|
| Fixed | Operators offer specific or generalized reservations, latter with travel times |
| capacity | within a window, equipment undefined, OD pair may or may not be defined, |
| with | to enable itinerary flex. |
| schedules | Within fixed capacity, operator may operate a fleet of varying aircraft, for |
| locked in | example 9, 19, and 44 seats, matching capacity to route demand. For |
| advance | significantly greater flexibility such aircraft may utilize electric propulsion, |
| | with remotely piloted or fully autonomous flight. |
| | Operators shift demand from busy to lighter itineraries by offering travelers |
| | legs that upgrade or downgrade their utility, via visibility to their travel |
| | objectives and preferred itineraries. |
| | Operators may negotiate for changes in passenger utility to maximize |
| | operator margin, e.g. offering upgraded utility for a premium, or offering |
| | compensation for moving a passenger to a lower utility flight while filling |
| | the same seat with a higher fare. |
| | Operators encourage travelers to change or cancel itineraries when these |
| | improve the operators' capacity, e.g., change from busy to light itineraries, |
| | cancel from busy flights where resale at higher fare is likely. |
| | Operators may shift fractions of cargo and passenger, filling out light |
| | passenger demand with less time sensitive cargo |
| | In case of flights with reduced payload fraction and a hybrid-electric aircraft, |
| | operator may utilize available payload to increase stored energy (e.g. |
| | additional battery modules), reducing DOC to partially offset reduced load |
| | factor. Similarly, in case of high demand, stored energy may be reduced to |
| | increase payload available, the increased revenue offsetting the increased |
| | DOC. |
| Variable | Operators offer specific or generalized reservations, latter with travel times |
| capacity | within a window, equipment undefined, to enable capacity flex. |
| with locked | Operators flex based on combination of real and forecast demand. |
| base plus | Operators respond to itinerary requests with availability or likelihood of |
| flex | clearing. |
| | Operators may tap additional capacity to meet peak demands, utilizing a |
| | lease pool or similar. Similarly, operators may offer aircraft on a lease pool |
| | at times of reduced demand. |
| | Operators may utilize low demand points for periodic maintenance to avoid |
| | downtime during higher demand periods. |
| Flex across | Operators collaborate to cover busy itineraries, shifting demand to others |
| operators | with availability, and engaging variable and on-demand players as needed. |

VARIABLE SCHEDULES

| | |
|---|---|
| Demand | Operators offer specific or generalized reservations, latter with travel times |
| matched | and end-points within windows, equipment undefined, to enable schedule |
| | flex. |
| | Operators determine schedule based on combination of real and forecast |
| | demand. |
| | Schedule may continue to evolve to optimize operator margin and passenger |
| | utility as flight date approaches. |
| | Generalized reservations and flexible schedules to transition to specific |
| | reservation and itinerary at operator determined time window prior to |
| | departure date. |
| | Operators respond to itinerary requests with availability or likelihood of |
| | clearing. |
| On-request | Operators offer specific or generalized reservations, latter with travel times |
| provisional | and end-points within windows, to enable schedule flex. |
| | Operators respond to itinerary requests with a provisional itinerary and |
| | likelihood of clearing, or by declining if match with operations is poor, |
| | capacity not available. |
| | Provisional itineraries cleared if demand crosses threshold and capacity |
| | available. |

ON-
DEMAND

Operators respond to requests by confirming a reservation, or by declining if
the match with operations is poor, capacity is not available.
Operators or travelers may offer excess capacity on itineraries to others.

Capacity management in this fluid environment proceeds in stages, from initialization of the network many months ahead of travel, refinement over the months that follow as travelers and shippers express demand, closing over the final days leading to travel, and orchestration on the day of travel. Processes vary across these periods, but split roughly to the following: forecast demand, define footprint and fleet; determine candidate itineraries (e.g., optimal itineraries); assign capacity to transport requests.

Initialization Phase

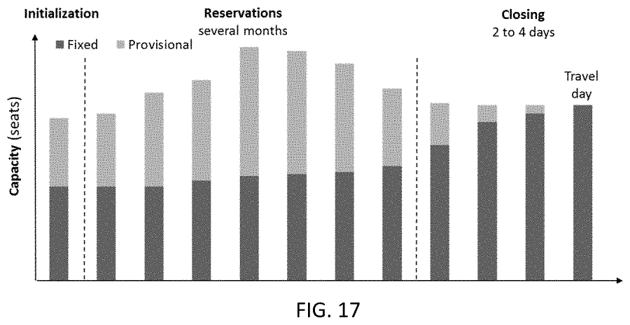

Prior to opening of reservations, often many months ahead of the day of travel, a first provisional schedule for the day is determined to serve an initial demand forecast. A portion of this schedule may be treated as “fixed” given high likelihood of those itineraries being offered; the remainder is treated as “provisional”. Operators are able to commit to specific itineraries within the fixed schedule, but only on a generalized basis in the provisional schedule. As demand is expressed over time and the forecast refreshed, increasing portions of the schedule shift from provisional to fixed, leading in stages to a fully fixed schedule that is molded to demand as illustrated in FIG. 17. To accommodate this evolution, operators determine a reservation strategy that determines how fixed or provisional capacity is allocated to demand, and what commitments are made to a traveler or shipper. The latter may include reservation of specific itineraries within the fixed portion of the schedule, or provisional reservations of specific itineraries along with identified backup itineraries that still meet transport objectives. These may also include generalized reservations that meet transport objectives which are converted by the operator to specific itineraries closer to the day of travel. Some operators will commit to door-to-door itineraries, others will limit themselves to terminal to terminal legs. The approach to allocated capacity, as well as the choice of commitments, will vary by operator based on their individual revenue management approach.

In the initialization phase, demand is forecast using single or multiple product origin-destination multiplicative demand models with factors for market elasticity to door-to-door times and fares. Demand may be forecast for multiple scenarios of varying aggressiveness. Demand is assessed based on traveler origin and destination pair (or nearby landmarks) and time objectives relative to these, versus transport terminals as is conventional practice. For example, demand may be described via origin and destination zip codes and associated departure or arrival times. Corresponding door-to-door times and fares are then calculated by summing across the air and ground legs, the latter weighted by use across the variety of ground modes.

Terminals and equipment to serve the targeted demand are determined. Terminals include hubs and non-hubs, former typically with defined departure and arrival slots, the latter much more flexible. Equipment is conventional and electric aircraft, the latter of much greater variety of sizes, including piloted aircraft as well as drones. Tiers of terminals and equipment may be identified aligned with varying levels of demand, and reflecting operator ability to vary capacity in response to overall demand (e.g., service offerings, maintenance schedules, lessor or 3rd party agreements). Specific itineraries are then calculated via time-space network optimization methods with heuristics. These seek to maximize the utility of the demand served at minimal operating cost across the defined terminals and equipment, factoring in a set of pre-fixed itineraries, and varying constraints at the terminals served. Mathematical approach is typically as a mixed integer problem (MIP), with nonlinear optimization methods such as Sequential Quadratic Programming (SQP). Heuristics are used extensively to make “larger” (i.e. realistic) problems tractable within a useful timeframe.

The degree of certainty of individual itineraries is assessed to differentiate itineraries that have a high likelihood of being offered (e.g., pre-fixed routes) from those that are more changeable. This is determined via a combination of factors, including forecast utilization or profitability of the service, utility of the route relative to nearby alternatives (e.g., varying based on origin-destination locations, time preferences, traffic conditions to-terminal and from-terminal), overall demand and capacity. For example, certainty may be determined by optimizing the network for varying levels of demand and travel conditions to generate alternate schedules from which the certainty of individual itineraries can be derived.

A reservations strategy is defined to guide how the two sides of the demand matching process proceed: the operator-facing assignment of capacity from a provisional schedule to demand; and the traveler or shipper-facing commitments made. This also determines what schedule is published, and the details of specific and generalized itineraries listed. As noted earlier, this will vary by operator based on individual revenue management approaches.

Reservation Phase

As transport requests arrive from the opening of reservations to travel, the demand forecast is refined to leverage this “expressed demand” and the provisional schedule, including the fixed vs. provisional split, is refreshed to match the updated forecast. This process is repeated periodically so that the schedule is molded optimally to demand. And as expressed demand increases relative to the forecast, increasing portions of the schedule shift from provisional to fixed.

Operator response to transport requests is determined by the reservation strategy. Capacity is assigned from the provisional schedule to meet the transport need, typically via a specific itinerary along with back-up alternatives that satisfy objectives. And a commitment is made to the traveler or shipper, in form of a specific or generalized itinerary, door-to-door or terminal-to-terminal. In event of a generalized reservation, a timeline for conversion to specific is also defined.

To accomplish this, the demand forecast is first refined by coupling the demand model with an expressed demand predictor/corrector algorithm. Expressed demand includes specific and generalized reservations, held and preferred itineraries, and may also include other signals of demand, e.g., search volumes. This enables continuing improvement of the demand forecast as expressed demand grows to increasing fractions of the forecast. Terminals and equipment are updated based on the improved demand forecast and other contingencies. This may include additions to the fleet and extensions to additional terminals to accommodate higher demand, terminal or ground travel disruptions.

Following this, the time-space network optimization to determine schedules is refreshed based on the refined demand forecast. Baseline optimization is supplemented with additional constraints to reflect the committed itineraries, reserved or held. Where modifying requirements of select travelers and shippers significantly improves the solution, opportunity to adjust terms is assessed and the optimization is adjusted on that basis. Certainties of individual itineraries are then updated using methods described previously, with the added constraint from the already committed itineraries. Published schedules and reservations strategy are updated to reflect these changed certainties.

Committed itineraries are reassigned to the updated schedule based on the optimized solution, including negotiation with travelers and shippers where the change is contrary to prior agreement. The refreshed fixed vs. provisional split is translated to updated commitments to travelers and shippers, typically increasing the volume of specific reservations. Some or all of these changes are communicated.

Travelers and shippers express demand by requesting reservations and holds, or indicating preferred itineraries, defined in generalized form by origin-destination and preferred times (or their equivalent at the origin-destination terminals), or by indicating a published itinerary. Operators respond to this expressed demand by assigning each provisionally to an itinerary or itineraries (e.g., primary with alternates) that meet transport objectives while maximizing traveler or shipper utility and operator profit margin. And by returning with a commitment to the traveler or shipper, in form of a specific or generalized itinerary, door-to-door or terminal-to-terminal. In event of a generalized reservation, a timeline for conversion to specific is also defined.

If capacity to meet a request is not available, options to reassign existing demand within constraint of individual travel objectives are explored, or the request is accepted provisionally pending update of schedules based on likelihood that the request will clear (determined as described previously or be some other method). This likelihood may be communicated to the traveler or shipper to assist with their decision. Provisional reservations are reviewed following schedule updates, changes or cancellations, and refreshed to reflect availability or likelihood of coming available.

Travelers and shippers also request changes or cancelations to their committed itineraries. Changes are handled much like new demand described previously. Both changes and cancelations involve a release of capacity, and an assessment of costs determined by the terms of the committed itinerary.

Closing Phase

In the final days ahead of travel, the demand forecast and schedule is further optimized based on expressed demand but also by factoring in travel conditions and other contingencies that have a material impact on the operator, traveler or shipper. Arriving transport requests are handled as described previously. And given impending travel, most commitments are converted to specific itineraries, or windows with timeline for conversion to specific.

The demand forecast is refined periodically by enhancing the demand model and expressed demand predictor/corrector algorithm with a model for the effect of travel conditions. These include factors such as traffic, weather, events, holidays that impact traveler and shipper objectives or utilities. For instance, challenging weather or traffic conditions may alter departure or arrival times to avoid the affected period, or alter departure and arrival terminals to those that are positioned to skirt the challenge. Terminals and equipment are adjusted to respond to evolving demand and contingencies.

The time-space network optimization is refreshed based on combination of committed itineraries, the updated demand forecast, travel conditions and contingencies. For instance, the utility of demand includes the condition of traffic on ground legs to and from the terminals, and deterioration of these may shift preference to alternate terminals. Certainties of individual itineraries are then refreshed, along with updates to published schedules and reservations strategy. Given proximity to travel, much of the schedule is typically fixed at this point, with only targeted uncertainty remaining.

Requests for transport, or change to committed itineraries are handled as described previously.

Committed itineraries are reassigned to near final schedules based on the optimized solution, including negotiation with travelers and shippers where the change is contrary to prior agreement. The refreshed fixed vs. provisional split is translated to updated commitments to travelers and shippers. Given proximity to travel, most itineraries are converted to specific, or clear paths to this conversion are determined.

Final transport guidance is communicated to travelers and shippers. This may include specific itineraries, or their generalized equivalents along with timeframe for these being made specific. For instance, this may include detail on a departure window along with timeline by when a specific departure time will be communicated. This guidance is also communicated to transport orchestrators or adjacent transport providers to enable multi-modal coordination.

Orchestration Phase

On the day of travel, capacity is adjusted in response to unexpected traveler, shipper and operational needs. Based on the nature of issue, the adjustment may involve network-wide optimization, or be limited to discrete itineraries. The adjustments are communicated to the range of stakeholders in real-time to enable responsive and seamless multi-modal orchestration.

Traveler and shipper progress is monitored directly or via orchestrators to identify if itinerary is at risk, e.g., delays, no-shows. Operations are monitored for risk to on-time performance. Terminal and equipment alternatives are identified in response where needed to address schedule gaps. If issues have significant impact on more than a few itineraries, a time-space network optimization is triggered to update the schedule, leveraging visibility to transport objectives to determine alternate itineraries that maximize utility.

More localized issues are addressed individually. In event of a delayed departure, for instance, travelers and shippers whose objectives are at risk are rerouted to itineraries that meet their objectives. This may include change for some that are not affected, within constraints of their objectives and utilities, to create capacity for the displaced. Individual journeys are similarly adjusted proactively in event of a disruption or delay so the traveler or shipper is rerouted in ways that minimize impact on objectives.

Final schedules and payloads are also used determine optimal energy plans and onboard storage for each flight, factoring for turnaround required, as well as recharge, swap and refuel capabilities at each of the terminals served.

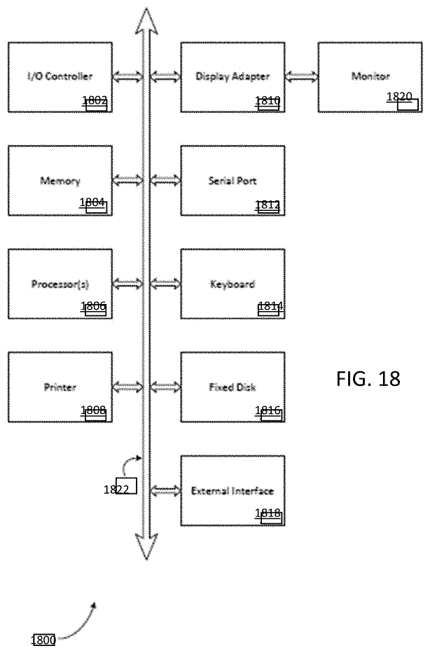

In accordance with some inventive aspects, the system, apparatus, methods, elements, processes, functions, and/or operations for enabling the inventive platform and transport system disclosed herein may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 18 is a diagram illustrating elements or components that may be present in a computer device or system 1800 configured to implement a method, process, function, or operation in accordance with some inventive aspects described herein. The subsystems shown in FIG. 18 are interconnected via a system bus 1822 (as may also be one or more of the subsystems illustrated in FIG. 18). Additional subsystems include a printer 1808, a keyboard 1814, a fixed disk 1816, and a monitor 1820, which is coupled to a display adapter 1810. Peripherals and input/output (I/O) devices, which couple to an I/O controller 1802, can be connected to the computer system by any number of means known in the art, such as a serial port 1812. For example, the serial port 1812 or an external interface 1818 can be utilized to connect the computer device 1800 to further devices and/or systems not shown in FIG. 18 including a wide area network such as the Internet, a mouse input device, and/or a scanner. The interconnection via the system bus 1822 allows one or more processors 1806 to communicate with each subsystem and to control the execution of instructions that may be stored in a system memory 1804 and/or the fixed disk 1816, as well as the exchange of information between subsystems. The system memory 1804 and/or the fixed disk 1816 may embody a tangible computer-readable medium.

### CONCLUSION

As used herein, the terms “optimal,” “optimized,” “optimizing,” used in specification and claims are intended to generally cover, for example, best possible solution, most favorable solution, and/or merely an improved solution. For example, in some instances it is possible that “optimizing/optimal” described herein may generate a solution that may not be the best possible solution or most favorable solution, but instead an improved solution (that may fall short of the best possible solution). In such instances, methods described herein may optionally generate the best possible solution, the most favorable solution or an improved solution, depending on one or more aspects such as one or more input data, model parameters, updated parameters, variables associated with the input data, the type of input source devices, other characteristics associated with the input source devices, and/or type of constraints involved in performing “optimization.” In a similar manner, in some instances, it is possible that the best possible solution may not necessarily be an improved solution and vice versa.

Furthermore, although embodiments of the present disclosure may achieve advantages over other possible solutions and/or over the prior art, whether or not a particular advantage is achieved by a given embodiment is not limiting of the present disclosure. Thus, the following aspects, features, embodiments and advantages are merely illustrative and are not considered elements or limitations of the appended claims except where explicitly recited in a claim(s).

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A computer-facilitated method for generating a multi-modal itinerary for a journey comprising at least a first segment defined by a first origin and a first destination, wherein:
the first segment includes a first plurality of legs;
the first plurality of legs includes:
at least a first long-distance leg defined by a first departure terminal and a first arrival terminal respectively corresponding to first start and end points of the first long-distance leg; and
at least a first local leg defined by one of:
the first origin of the first segment and the first departure terminal of the first long-distance leg; and
the first arrival terminal of the first long-distance leg and the first destination of the first segment; and
the first long-distance leg includes at least a first long-distance transport mode having one of a fixed schedule (FS) model, a variable schedule (VS) model and an on-demand (OD) schedule model provided by a first operator between the first departure terminal and the first arrival terminal,
the method comprising:
A) receiving a first objective for the first segment of the journey, the first objective comprising first origin coordinates for the first origin of the first segment, first destination coordinates for the first destination of the first segment, and a first time window for the first segment, wherein the first time window comprises a departure time specification for the first origin of the first segment and an arrival time specification for the first destination of the first segment;
B) querying a mode/origin-destination (M/OD) database, using the first objective received in A), wherein:
B1) the M/OD database includes a plurality of origin-destination pairs respectively corresponding to different long-distance legs;
B2) at least a first origin-destination pair of the plurality of origin-destination pairs includes:
B2a) a departure terminal for a long-distance leg;
B2b) an arrival terminal for the long-distance leg;
B2c) a long-distance transport mode and corresponding duration for the long-distance transport mode between the departure terminal and the arrival terminal for the long-distance leg, wherein:
the long-distance transport mode includes at least one of a long-haul air transport mode, a regional air transport mode, a railway transport mode and a highway transport mode; and
the long-distance transport mode has one of a variable schedule (VS) model and an on-demand (OD) schedule model;
B2d) at least one of an operator, a platform, and a marketplace that provides the long-distance transport mode; and
B2e) at least one local leg transport mode option corresponding to the departure terminal and the arrival terminal for the long-distance leg;
C) in response to B), building a list of long-distance transport mode options for the first long-distance leg by selecting from the M/OD database at least a first candidate origin-destination pair as at least a first long-distance transport mode option for the first long-distance leg, wherein:
C1) the first candidate origin-destination pair includes a first candidate long-distance transport mode having a variable schedule (VS) model or an on-demand (OD) schedule model; and
C2) the first candidate origin-destination pair is selected based at least in part on at least one of:
C2a) at least one of a first distance and a first transit time between the first origin coordinates for the first origin of the first segment and the departure terminal of the first candidate long-distance transport mode; and
C2b) at least one of a second distance and a second transit time between the arrival terminal of the first candidate long-distance transport mode and the first destination coordinates for the first destination of the first segment; and
D) for at least the first long-distance transport mode option of the list of long-distance transport mode options from C):
D1) determining an estimated duration for the at least one local leg transport mode option corresponding to the departure terminal for the first candidate long-distance transport mode;
D2) converting the first departure specification of the first time window for the first segment to a converted first departure specification for the first candidate long-distance transport mode based at least in part on the estimated duration for the at least one local leg transport mode option;
D3) transmitting, via the Internet, a first generalized transport request to at least one of a first candidate operator, a first candidate platform, and a first candidate marketplace indicated in the first candidate origin-destination pair corresponding to the first long-distance transport mode option, wherein the first generalized transport request includes:
the departure terminal and the arrival terminal indicated in the first candidate origin-destination pair corresponding to the first long-distance transport mode option; and
the converted first departure specification in D2); and
E) receiving via the Internet, in response to the first generalized transport request in D3) and from the at least one of the first candidate operator, the first candidate platform, and the first candidate marketplace, a first candidate itinerary for the first long-distance leg of the first segment, wherein the first candidate itinerary is a generalized itinerary comprising a first travel time departure window, a first travel duration, and a first fare for the first long-distance leg of the first segment.

2. (canceled)

3. The method of claim 2, wherein the travel distance between the first departure terminal and the first arrival terminal of the first long-distance leg is from 50 miles to 500 miles.

4. The method of claim 1, wherein:
the first long-distance transport mode includes the regional air transport mode having the variable schedule (VS) model or the on-demand (OD) schedule model; and
the regional air transport mode uses hybrid-electric aircraft.

5.-8. (canceled)

9. The method of claim 1, further comprising:
F) transmitting via the Internet, to the at least one of the first candidate operator, the first candidate platform, and the first candidate marketplace and in response to the first candidate itinerary, a reservation for the first long-distance leg of the first segment via a hybrid-electric aircraft.

10.-11. (canceled)

12. The method of claim 1, further comprising F) periodically refreshing the first candidate itinerary by repeating D3) and E) based at least in part on at least one of:
a first transport status of the first long-distance transport mode;
a second transport status of the at least one local leg transport mode option associated with the first long-distance transport mode;
weather conditions;
traffic conditions; and
an event.

13. The method of claim 1, wherein the M/OD database in B) further comprises:
B3) at least a second origin-destination pair of the plurality of origin-destination pairs, wherein the second origin-destination pair includes:
B3a) a departure terminal for a long-distance leg;
B3b) an arrival terminal for the long-distance leg;
B3c) a long-distance transport mode and corresponding duration for the long-distance transport mode between the departure terminal and the arrival terminal for the long-distance leg, wherein:
the long-distance transport mode includes at least one of a long-haul air transport mode, a regional air transport mode, a railway transport mode and a highway transport mode; and
the long-distance transport mode has a fixed schedule (FS) model;
B3d) at least one of an operator, a platform, and a marketplace that provides the long-distance transport mode; and
B3e) at least one local leg transport mode option corresponding to the departure terminal and the arrival terminal for the long-distance leg.

14. The method of claim 13, wherein C) further comprises, in response to B):
selecting from the M/OD database at least a second candidate origin-destination pair as at least a second long-distance transport mode option for the first long-distance leg, wherein:
the second candidate origin-destination pair includes a second candidate long-distance transport mode having a fixed schedule (FS) model; and
the second candidate origin-destination pair is selected based at least in part on at least one of:
C2a) at least one of a third distance and a third transit time between the first origin coordinates for the first origin of the first segment and the departure terminal of the second candidate long-distance transport mode; and
C2b) at least one of a fourth distance and a fourth transit time between the arrival terminal of the second candidate long-distance transport mode and the first destination coordinates for the first destination of the first segment.

15. The method of claim 14, wherein D) further comprises, for the second long-distance transport mode option of the list of long-distance transport mode options from C):
D4) determining an estimated duration for the at least one local leg transport mode option corresponding to the departure terminal for the second candidate long-distance transport mode;
D5) converting the first departure specification of the first time window for the first segment to a converted first departure specification for the second candidate long-distance transport mode based at least in part on the estimated duration for the at least one local leg transport mode option in D4);
D6) transmitting, via the Internet, a second generalized transport request to at least one of a second candidate operator, a second candidate platform, and a second candidate marketplace indicated in the second candidate origin-destination pair corresponding to the second long-distance transport mode option, wherein the second generalized transport request includes:
the departure terminal and the arrival terminal indicated in the second candidate origin-destination pair corresponding to the second long-distance transport mode option; and
the converted first departure specification in D5).

16. The method of claim 15, wherein E) further comprises:
receiving via the Internet, in response to the second generalized transport request in D6) and from the at least one of the second candidate operator, the second candidate platform, and the second candidate marketplace, a second candidate itinerary for the first long-distance leg of the first segment, wherein the second candidate itinerary is a specific itinerary comprising a second candidate itinerary departure time, a second travel duration, and a second fare for the first long-distance leg of the first segment.

17-35. (canceled)

36. A computer-facilitated method for monitoring the progress of a traveler or shipped object during a first segment of a journey and updating at least one itinerary for the first segment of the journey to meet a first objective for the first segment, wherein:
the first segment is defined by a first origin and a first destination;
the first objective comprises the first origin of the first segment, the first destination of the first segment, and a first time window for the first segment, wherein the first time window comprises a departure time specification for the first origin of the first segment and an arrival time specification for the first destination of the first segment;
the first segment includes a first plurality of legs;
the first plurality of legs includes:
at least a first long-distance leg defined by a first departure terminal and a first arrival terminal respectively corresponding to first start and end points of the first long-distance leg; and
at least a first local leg defined by one of:
the first origin of the first segment and the first departure terminal of the first long-distance leg; and
the first arrival terminal of the first long-distance leg and the first destination of the first segment;
the first long-distance leg includes at least a first long-distance transport mode having one of a fixed schedule (FS) model, a variable schedule (VS) model and an on-demand (OD) schedule model provided by a first operator between the first departure terminal and the first arrival terminal; and
the first local leg is provided by a second operator different from the first operator;
the method comprising:
A) prior to the journey, building a timeline for the first segment based at least in part on respective forecasted durations for the first long-distance leg and the first local leg, the timeline comprising a plurality of expected times and corresponding locations of the traveler or shipped object during the first segment that meet the first objective for the first segment; and
B) during the first journey:
B1) determining, from the timeline for the first segment and a current time, a current leg of the first segment;
B2) if the current leg of the first segment is the first long-distance leg, transmitting, via the Internet, a first query to the first operator and receiving from the first operator a first long-distance leg arrival status of the first long-distance leg;
B3) if the current leg of the first segment is the first local leg, monitoring a current location of the traveler or the shipped object; and
B4) if the first long-distance leg arrival status significantly deviates from a corresponding expected time according to the timeline, or if the current location of the traveler or the shipped object significantly deviates from a corresponding expected location according to the timeline:
B4a) recalculating the timeline for the first segment based on the first long-distance leg arrival status or the current location of the traveler or shipped object;
B4b) comparing the recalculated timeline to the first objective; and
B4c) if the recalculated timeline does not meet the first objective, generating an updated itinerary for at least one subsequent leg of the first segment.

37. The method of claim 36, wherein B) further comprises:
monitoring at least one transport condition relative to the at least one subsequent leg of the first segment,
wherein B4a) comprises recalculating the timeline for the first segment based on:
the monitored at least one transport condition relative to the at least one subsequent leg; and
the first long-distance leg arrival status or the current location of the traveler or shipped object.

38. (canceled)

39. The method of claim 37, wherein:
during B), the first objective is changed to an updated first objective;
B4b) comprises comparing the recalculated timeline to the updated first objective; and
in B4c), if the recalculated timeline does not meet the updated first objective, generating an updated itinerary for the at least one subsequent leg of the first segment.

40. The method of claim 36, wherein in B4c):
the current leg of the first segment is the first local leg;
the at least one subsequent leg is the first long-distance leg; and
generating the updated itinerary for the first long-distance leg comprises:
determining an estimated arrival time of the first local leg at or near the first departure terminal of the first long-distance leg;
converting the first departure specification of the first time window for the first segment to a converted first departure specification for the first long-distance leg based at least in part on the estimated arrival time for the first local leg;
transmitting, via the Internet, a generalized transport request to the first operator, wherein the generalized transport request includes:
the first departure terminal and the first arrival terminal for the first long-distance leg; and
the converted first departure specification in B5b); and
receiving via the Internet, in response to the generalized transport request in and from the first operator, a first updated itinerary for the first long-distance leg of the first segment, wherein the first updated itinerary is a generalized itinerary comprising a first travel time departure window, a first travel duration, and a first fare for the first long-distance leg of the first segment.

41. A computer-facilitated method for generating, by a transportation operator, a daily schedule for a plurality of long-distance transport mode trips, the method comprising:
A) determining a first provisional schedule on a given day for the plurality of long-distance transport mode trips based on a forecast demand for capacity, wherein:
respective long-distance transport mode trips of the plurality of long-distance transport mode trips having corresponding itineraries;
a first number of the corresponding itineraries are specific itineraries including a departure terminal, an arrival terminal, a departure time, and a duration for a corresponding long-distance transport mode trip; and
a second number of the corresponding itineraries are generalized itineraries including at least one of a departure terminal, an arrival terminal, a travel window, and a duration for a corresponding long-distance transport mode trip;
B) after A), receiving, from a plurality of travelers and/or shippers, a plurality of transport requests for at least some of the plurality of long-distance transport mode trips on the given day; and
C) updating the first provisional schedule, based at least in part on the plurality of transport requests received in B), to determine a second schedule for the plurality of long-distance transport mode trips, by increasing the first number of specific itineraries and decreasing the second number of generalized itineraries.

42. The method of claim 41, wherein in A), the forecast demand for capacity is based at least in part on a demand model comprising at least one of market elasticity factors, door-to-door times for origin-to-destination travel segments that include at least one of the plurality of long-distance mode trips, and respective fares for at least some of the plurality of long-distance mode trips.

43.-45. (canceled)

46. The method of claim 41, wherein in B):
a first number of the plurality of transport requests for the at least some of the plurality of long-distance transport mode trips on the given day are specific transport requests; and
a second number of the plurality of transport requests for the at least some of the plurality of long-distance transport mode trips on the given day are generalized transport requests.

47. (canceled)

48. The method of claim 41, wherein C) further comprises:
C1) updating the forecast demand for capacity based on the plurality of transport requests received in B); and
C2) determining the second schedule for the plurality of long-distance transport mode trips based at least in part on the updated forecast demand for capacity in C1).

49-50. (canceled)

51. The method of claim 48, wherein:
A) further comprises selecting at least one of respective departure terminals, respective arrival terminals, and respective travel equipment for at least some of the respective long-distance transport mode trips of the plurality of long-distance transport mode trips based at least in part on the forecast demand for capacity; and
C2) further comprises updating at least one of the respective departure terminals, the respective arrival terminals, and the respective travel equipment for at least some of the respective long-distance transport mode trips of the plurality of long-distance transport mode trips based at least in part on the updated forecast demand for capacity in C1).

52.-57. (canceled)

58. The method of claim 48, further comprising:
D) after C), repeating B) to receive additional transport requests for at least some of the plurality of long-distance transport mode trips on the given day;
E) updating the second schedule, based at least in part on the additional transport requests received in D), to determine at least one additional schedule for the plurality of long-distance transport mode trips, by further increasing the first number of specific itineraries, wherein E) comprises:
adjusting the number of the plurality of long-distance transport mode trips on the given day based at least in part on at least one canceled reservation or at least one no-show for at least one of the long-distance transport mode trips.

59. The method of claim 41, wherein E) further comprises:
E1) further updating the updated forecast demand for capacity based on the plurality of transport requests received in D); and
E2) determining the at least one additional schedule for the plurality of long-distance transport mode trips based at least in part on the further updated forecast demand for capacity in E1).

60.-65. (canceled)
